(19) United States
(12) Patent Application Publication
(10) Pub. No.: US 2026/0111768 A1
(43) Pub. Date: Apr. 23, 2026

(54) SUPERVISED LEARNING USING HYPERDIMENSIONAL COMPUTING

(71) Applicant: Intel Corporation, Santa Clara, CA (US)

(72) Inventors: Narayan Srinivasa, San Jose, CA (US); Ryan Kim, Beaverton, OR (US)

(21) Appl. No.: 19/253,762

(22) Filed: Jun. 28, 2025

(51) Int. Cl. G06N 5/04

(52) U.S. Cl. CPC G06N 5/04

(57) ABSTRACT

Techniques for at least supervised learning using hyperdimensional computing (HDC). A framework and model for learning using HDC are described. In some examples, the framework uses two instances of the HDC model. A first learning module learns common patterns. These patterns may be learned from streaming data for a given classification task in one shot without requiring large off-chip memory for multi-shot training. A second learning module learns difficult and/or uncommon patterns from the common patterns learned by the first learning module.

### BACKGROUND

Hyperdimensional computing (HDC) is inspired by how the brain works with neural activities in high-dimensional space. HDC maps data points into high-dimensional space (e.g., 10,000 dimensions) and a mostly linear training process is performed to learn (train) a HDC model. HDC is well suited to address learning tasks for internet-of-things (IoT) systems as HDC models are computationally efficient (highly parallel and may not utilize as much memory to store a model such as weight-based neural networks), generally amenable to hardware level optimization, offer an intuitive and human-interpretable model, offer a computational paradigm that can be applied to cognitive as well as learning problems, and provide strong robustness to noise.

### BRIEF DESCRIPTION OF DRAWINGS

Various examples in accordance with the present disclosure will be described with reference to the drawings, in which:

FIG. 1 illustrates examples of HDC usage.

FIG. 2 illustrates examples of generating codebooks for encoding.

FIG. 3 illustrates examples of encoding data into a hypervector.

FIG. 4 illustrates examples of a prior art implementation of single-pass HDC model training.

FIG. 5 illustrates examples of an HDC learning architecture.

FIG. 6 illustrates examples of a flow for a method of training an HDC machine learning model.

FIG. 7 illustrates other examples of a flow for a method of training an HDC machine learning model.

FIG. 8 illustrates a flow for performing inference using a trained HDC machine learning model.

FIG. 9 illustrates examples of inference for HDC.

FIG. 10 illustrates examples of systems that support supervised learning using hyperdimensional computing.

FIG. 11 illustrates examples of a cloud provider network.

FIG. 12 illustrates an example computing system.

FIG. 13 illustrates a block diagram of an example processor and/or System on a Chip (SoC) that may have one or more cores and an integrated memory controller.

FIG. 14 is a block diagram illustrating a computing system configured to implement one or more aspects of the examples described herein.

FIGS. 15A-15C illustrate additional graphics multiprocessors, according to examples.

FIG. 16 is a block diagram illustrating an intellectual property (IP) core development system that may be used to manufacture an integrated circuit to perform operations according to some examples.

### DETAILED DESCRIPTION

The present disclosure relates to methods, apparatus, systems, and non-transitory computer-readable storage media for at least HDC learning. Existing HDC algorithms support single-pass training where the learning of a HDC model is achieved by examining each training data point only once.

While single-pass learning may allow fast and real-time learning, it often results in poor classification accuracy. This is because single-pass HDC learning naïvely accumulates hypervectors to generate class hypervectors. Eventually, this causes the bits in the hypervector to saturate which results in information being “forgotten.” For example, in face recognition tasks, single-pass training can achieve only approximately 70% classification accuracy which is 25% lower than other state-of-the-art algorithms.

To address this issue, previous research introduced the concept of HDC iterative training (a.k.a. retraining). Although retraining significantly restores HDC classification accuracy to levels comparable with state-of-the-art methods, it negates the benefits of the single-pass model of being fast and real-time. For example, retraining requires devices to use large off-chip memory to store all training samples, which can be a significant drawback especially in a cloud provider network with shared resources.

Another approach to improving single-pass learning is an adaptive training framework and model for efficient and accurate HDC learning where the model identifies common patterns during single-pass training and eliminates the saturation of the class hypervectors. This is achieved by first computing the similarity of the input data with the existing class hypervectors and then adding only a small portion of the data if it already exists in a class hypervector. This addresses the saturation problem and weights uncommon patterns reasonably in the final model. However, this model requires more than one pass (at least in the order of 8-10 passes) to maximize its accuracy, and this does not overcome the large off-chip memory required as described above. A second issue is that the class hypervector requires costly cosine similarity computation for every data point leading to less efficient hardware implementation. A third issue is that two extra parameters, the similarity weight and the learning rate, must be estimated by trial and error, which can be costly.

Examples detailed herein address these deficiencies. In particular, a framework and model for learning using HDC are described. The efficiency comes from the ability to learn tasks in a single pass without adjusting the model's parameters on a trial-and-error basis and achieving similar accuracies as state-of-the-art deep models for identical tasks. This reduces computational and memory needs.

In some examples, two learning modules are used to learn patterns and update the model (e.g., on an inference or during initial training). A first learning module learns common patterns. These patterns may be learned from streaming data for a given classification task in one shot without requiring large off-chip memory for multi-shot training. A second learning module learns difficult and/or uncommon patterns from the common patterns learned by the first learning module. Further these modules find matches between a data hypervector and class hypervector using only a dot product, rather than cosine similarity, the learning approach more efficient for hardware implementations. The need for parameter adjustments through trial and error is also eliminated using the two-learning module approach, thereby avoiding the costly exploration phase typically required to set up the system for learning.

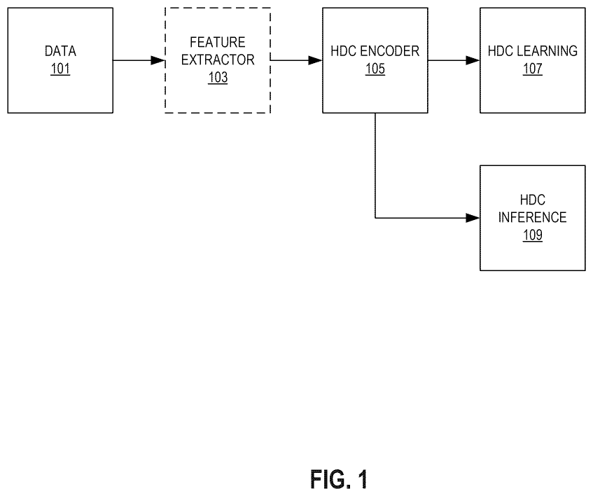

FIG. 1 illustrates examples of HDC usage. Data 101 may be used to train an HDC model and/or be used in HDC inference. A step in HDC is mapping data 101 (e.g., an N-dimensional data vector) into a high-dimensional space (or HDC space). This mapping may be called “encoding” and is performed by an HDC encoder 105 What encoding method to use for this mapping may be dependent on the data type. These output of an encoding operation is a hypervector.

Assuming an input vector in an original space (\vec{F}={f₁, f₂, . . . f_{N}} and F∈ [symbol] ⁿ an encoding module will map the input vector into a high-dimensional vector, H or H. An example of an encoding method to map an input vector into a high-dimensional space is

$$\vec{H} = {\sum }_{k = 1}^{N} {\vert {f}_{k} \vert}_{∈ F} \cdot {\vec{β}}_{k}$$

where bi-polar feature vectors \vec{β}ₖs are randomly chosen. Note that \vec{β}ₖ∈{−1, +1}^{D}.

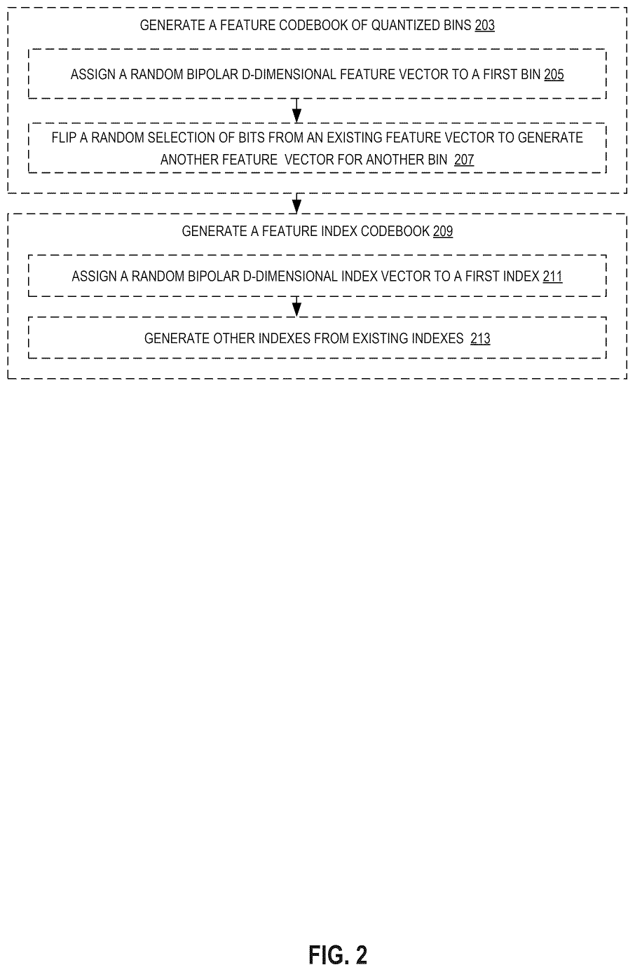

In some examples, to encode the input data 101, a codebook for feature values and another codebook for their index in the feature vector of dimension N are used. FIG. 2 illustrates examples of generating codebooks for encoding. These codebooks are constructed and stored once.

In some examples, a feature codebook of quantized bins is generated at 203. A step of the encoding process involves using a non-linear function (e.g., tan h) to normalize each value of input data vector di into the range (−1, 1). This range is then quantized into Q bins.

A random bipolar D-dimensional feature vector is randomly assigned to a first bin at 205. In some examples, the first bin

$$( values of - 1 to - 1 + \frac{2}{Q} )$$

is assigned a random bipolar D-dimensional vector β₁ (note β may be used for these vectors).

A random selection of bits from an existing feature vector are flipped to generate another feature vector for another bin at 207. For example, a high-dimensional (HD) vector β₂ for the next quantized bin may be generated by randomly selecting B bits in β₁ and flipping them. HD vector β₃ for the next quantized value may computed by randomly selecting B bits in β₂ and flipping them. This process is repeated to create the codebook for feature values (β₁, . . . , α). This maintains the bins' ordinal position property with respect to the distance between vectors in the feature codebook.

A feature index codebook is generated at 209. In some examples, a random bipolar d-dimensional index vector is assigned to a first index at 211. For example, random bipolar D-dimensional vector I₁ is assigned for a first index. In some examples, other indexes are generated from existing indexes at 213. For example, to obtain I₂ for second index, I₁ is rotated by J bits (J=D/N). This rotation process is repeated to create the codebook for the feature indices (I₁, . . . , I_{N}).

In some examples, prior to encoding, a feature extractor 103 converts raw input data into high-level features that are potentially more refined and informative than the raw input data. Examples of a feature extractor 103 include, but are not limited to neural networks (e.g., a deep neural network (DNN) model, or specialized conversion techniques such as Fourier transformation, Laplacian transformation, or wavelet transformation. When a feature extractor 103 is used the feature index codebook is adjusted to have M (the number of output features from the feature extraction module) hypervectors.

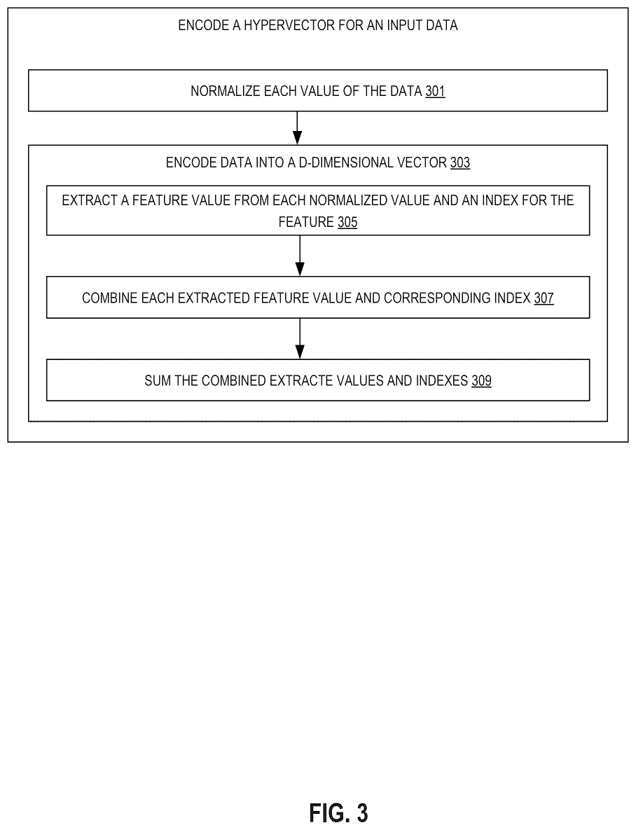

In some examples, the HDC encoder 105 embeds the data 101 into a hypervector by extracting corresponding HD vectors for each feature value and its index and then binding them together. FIG. 3 illustrates examples of encoding data into a hypervector. Each value of the data is normalized at 301. For example, each value of the data is made to between −1 and 1. The normalized values are encoded into a D-dimensional vector (hypervector (H)) at 303.

A feature value from each normalized value and an index for the feature are extracted at 305. These vectors are extracted from the codebooks detailed above.

Each extracted feature value and corresponding index are combined at 307. In some examples, the combination is a Hadamard product of these vectors.

The combined extracted values and indexes are summed at 309 to generate a hypervector.

For example, consider extracted HD vectors for the first feature value and the first index, denoted as F₁ and I₁. These two HD vectors are combined using the Hadamard product to form a new HD vector, F₁*I₁. This process of extraction and combination is repeated for all indices in the data or feature vector, resulting in the final HD vector H for the input data, expressed as H=F₁*I₁+ . . . +F_{N}*I_{N} (or M instated of N when feature extraction is first performed).

Encoded hypervectors are used to train a HDC model 108 using HDC learning module 107 and/or are used for HDC inference module 109. In some previous implementations, HDC models where trained using “single pass” training. In single pass-training, a training module combines hypervectors belonging to each class to form class hypervectors. That is hypervectors (H_{L} or \vec{H}_{L} where L indicates a class or label) are added to class hypervectors (C_{I} or \vec{C}_{L}).

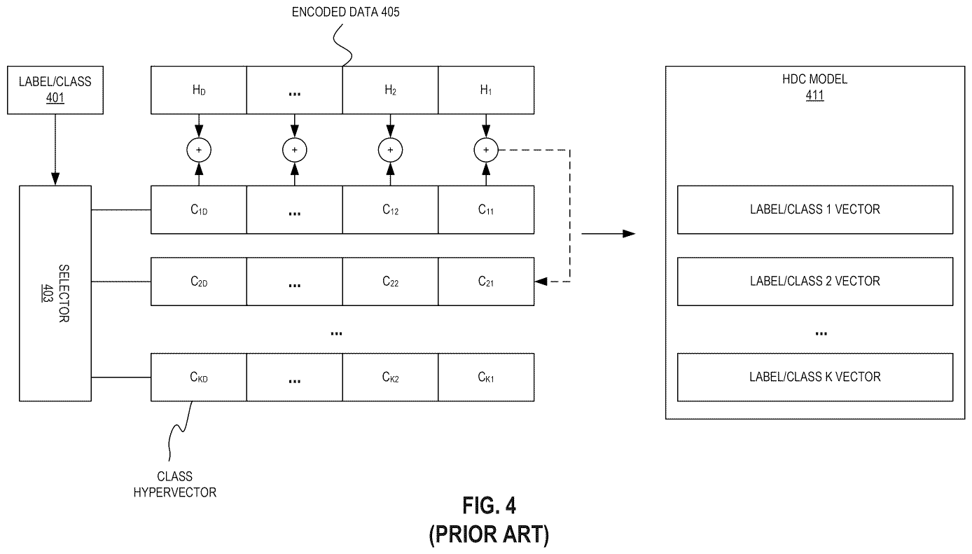

FIG. 4 illustrates examples of a prior art implementation of single-pass HDC model training. After generating all of the hypervector inputs belonging to class/label L, the class hypervector \vec{C}_{L} is obtained by bundling (adding) all \vec{H} s.

As shown, encoded data 405 (e.g., a single hypervector comprised of a plurality of hypervectors H₁ . . . H_{D}) is to potentially be added to one of k class hypervectors (shown as C₁, C₂, . . . Cₖ). The addition is called “bundling” and is an element-wise addition. A label (or class) indication 401 provides an input to a selector 403 to select a label/class vector to update. In this example, C₂ is to be updated based on the label/class indication 401.

The HDC model 411 is represented as the collection of label/class vectors (i.e., M={\vec{C}₁, \vec{C}₂, . . . , \vec{C}ₖ}).

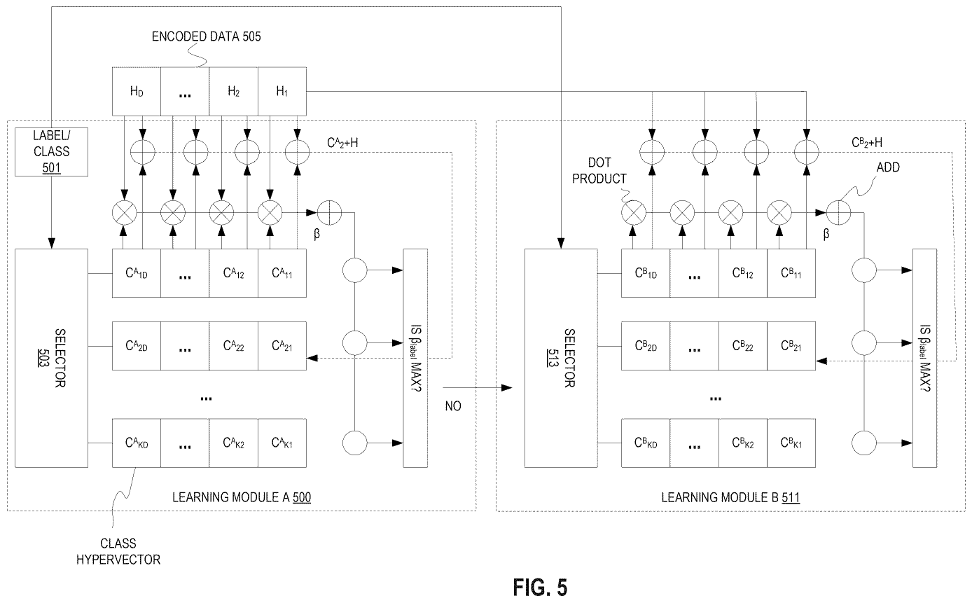

FIG. 5 illustrates examples of an HDC learning architecture. This HDC learning architecture includes two learning modules instead of the one learning module of traditional single-pass learning. In this illustration two learning (or memory) modules are labeled learning module A 500 and learning module B 511. These learning modules are capable of continuously learning from streaming data (e.g., initial training and/or after inference) to learn common and uncommon patterns in one shot. These learning modules are sized K×D (K labels or hypervectors, D data elements per hypervector) to store K class hypervectors. During the learning process, both modules may store K class hypervectors.

A label/class 501 is used to select class hypervector using selector 503 and/or selector 513. In this illustration, the class is class 2. As shown, the encoded data (hypervector) 505 may be added to the selected class hypervector using a plurality of adders.

For the initial training process of the model M, all of the class hypervectors (C^{A} and C^{B}) in both learning modules 500 and 511 are initialized to zero. Each class's first data hypervector H (encoded as described above) is added directly to its class hypervector in module A (e.g., using adders as shown for label 2 in the illustration).

For subsequent input data samples, a dot product is performed between each data value of the encoded data 505 and all of the class hypervectors C^{A} in module A 500 to determine if there is a label match. The dot product is the multiplication of corresponding data elements of the encoded data 505 and each class hypervector, wherein the result of the multiplications are summed in a K-element vector β for the class (e.g., one dot product for each class). In this example, β_{label} refers to the dot product per class/label. For example, β₂ is the dot product for class/label 2.

A higher dot product value indicates a better match for a given class hypervector. In this illustration, the determination is of if the encoded data 505 has a correct label of 2. In other words, is the β_{label} for label 2 (β₂) the largest β_{label} value. Note that the dot product is only shown for one class hypervector and data hypervector in this illustration (class/label 1).

If the best match corresponds to the class label (where β₂ is the maximum out of the β_{labels}), then the class hypervector C^{A}₂ is updated by adding the vector H (similar to the first data for a class). If there is not a match (i.e., β₂ is not the maximum such that any β_{label} other than β₂ is the maximum), the data hypervector H is passed to learning module B 511 and no update occurs in learning module A 500. This non-match indicates that there is an uncommon pattern to learn.

Like the learning module A 500 operation, in learning module B 511 the first data hypervector H for each class is added directly to its class hypervector. For subsequent data samples routed to learning module B 511, a match between each H and all the class hypervectors C^{B} in learning module B 511 is computed using a dot product as detailed with respect to learning module A 500.

Following the same example as learning module A 500, if the correct class label is 2 the class hypervector C^{B}₂ of that label is updated by adding the hypervector H. If there is a mismatch in learning module B 511, then the memory of learning module B 511 is added to learning module A 500, where C^{A} is now updated to be C^{A}+C^{B}. At the same time, all the class hypervectors C^{B} in module B are reset to zero (in some examples, except for the mismatching class which is left alone).

After training is complete, C^{A} and C^{B} are combined into a single class hypervector set (C^{A}=C^{A}+C^{B}) in learning module A 500. Inference requests are made against learning module A 500.

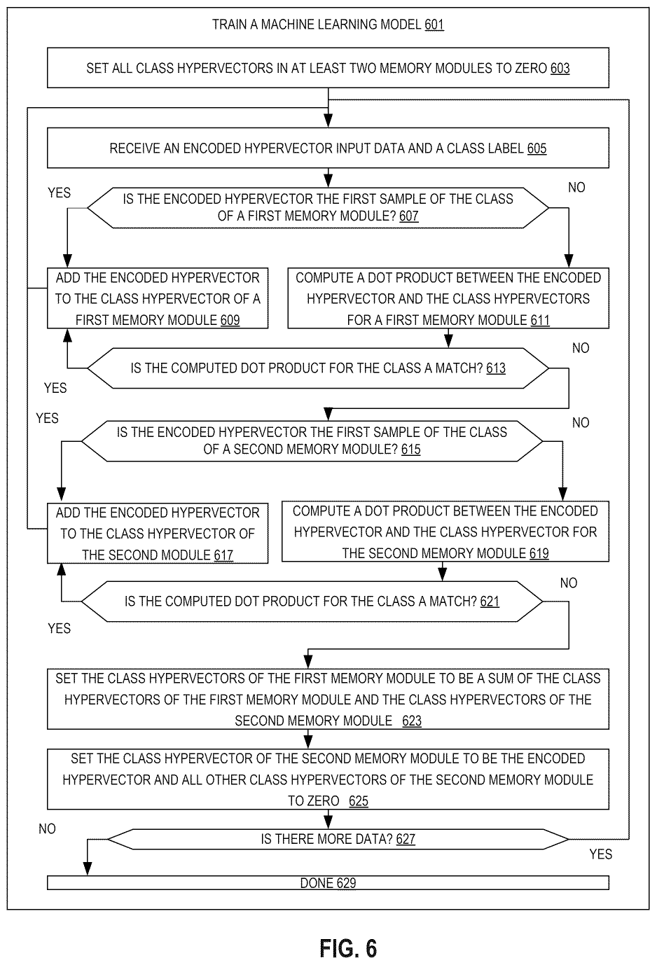

FIG. 6 illustrates examples of a flow for a method of training an HDC machine learning model. This machine learning model M includes the two memory modules described above. Examples of this method are implemented using HDC learning module 107 and encoder 105. In some examples, a feature extraction has occurred for the input data.

The HDC machine learning model is trained at 601. In some examples, this training is in response to a request. For example, a request to a machine learning service of a cloud provider network. In some examples, the request includes at least one of an identifier of a HDC machine learning model to train, an identifier of a HDC machine learning algorithm to train, an indication of a location for training data, an indication of a location for validation and/or testing data, an algorithm to use for encoding, an indication of where to store artifacts generated by the training of the machine learning model, an indication of the compute instance to use for training, etc.

All class hypervectors in at least two memory modules to zero at 603. This sets the memory modules to an initial state. Note that setting to zero should only happen once.

An encoded hypervector for input data is received along with a class label at 605. Examples of encoding have been detailed above. Encoding may use one or more codebooks.

A determination of if the encoded hypervector is the first sample of the class (as indicated by the received class label) of a first memory module is made at 607. For example, is there a class hypervector for the class that has a non-zero value?

If the encoded hypervector is the first sample of the class of the first memory module, the encoded hypervector is added to the class hypervector for the class of the first memory module at 609. If the encoded hypervector is not the first sample of the class (that is there is a class hypervector for the class that has a non-zero value), then a dot product between the encoded hypervector and each of the class hypervectors for the first memory module is calculated at 611. For example, a dot product between the encoded hypervector and a class hyper vector for class 1 is calculated, a dot product between the encoded hypervector and a class hyper vector for class 2 is calculated, etc.

A determination of if the computed dot product for the class is a match is made at 613. A match occurs when the computed dot product for the class has the highest value out of all of the computed dot products. Using the earlier example, if the class label is class 2 is the dot product for class 2 a match? If so, then the encoded hypervector is added to the class hypervector of the first memory module at 609. Note that acts 607-613 occur in the first memory module.

If there is no match for the label, then the encoded hypervector is passed to the second memory module and a determination is made of if the encoded hypervector is a first sample of the class in the second memory module is made at 615.

When the encoded hypervector is the first for the class in the second memory module, the encoded hypervector is added to the class vector of the second memory module at 617.

When the encoded hypervector is not the first sample of the class (that is there is a class hypervector for the class that has a non-zero value), then a dot product between the encoded hypervector and each of the class hypervectors for the second memory module is calculated at 619. For example, a dot product between the encoded hypervector and a class hyper vector for class 1 is calculated, a dot product between the encoded hypervector and a class hyper vector for class 2 is calculated, etc.

A determination of if the computed dot product for the class is a match is made at 621. A match occurs when the computed dot product for the class has the highest value out of all of the computed dot products. Using the earlier example, if the class label is class 2, is the dot product for class 2 a match? If there is a match, then the encoded hypervector is added to the class vector of the second memory module at 617.

If there is not a match, the class hypervectors of the first memory module are set to be a sum of the class hypervectors of the first memory module and the class hypervectors of the second memory module at 623.

The class hypervector of the second memory module is set to be the encoded hypervector and all other class hypervectors of the second memory module are set to zero 625.

A determination of if there is more data is made at 627. If not, then the training is done at 629. If there is more data, the next encoded hypervector and class indication is received at 605. Note that acts 615-627 occur in the second memory module in some examples.

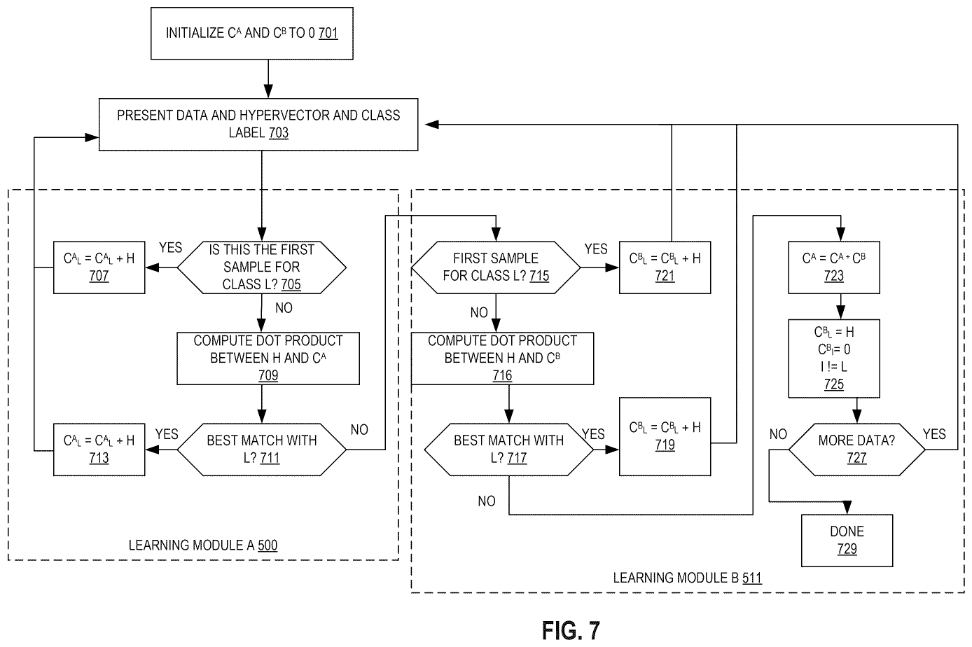

FIG. 7 illustrates other examples of a flow for a method of training an HDC machine learning model. All class hypervectors in at least two memory modules to zero at 701. This sets the memory modules to an initial state. Note that setting to zero should only happen once.

An encoded hypervector (H) for input data is received along with a class label (L) at 703. Examples of encoding have been detailed above. Encoding may use one or more codebooks.

A determination of if the encoded hypervector is the first sample of the class L (as indicated by the received class label) of a first memory module is made at 705. For example, is there a class hypervector for class L that has a non-zero value?

If the encoded hypervector is the first sample of the class L of the first memory module, the encoded hypervector is added to the class hypervector for the class

$$L ( {C}_{L}^{A} . )$$

of the first memory module at 707. In other words,

$${C}_{L}^{A} = {C}_{L}^{A} + H .$$

If the encoded hypervector is not the first sample of the class L (that is there is a class hypervector for the class that has a non-zero value), then a dot product between the encoded hypervector and each of the class hypervectors (C^{A}.) for the first memory module is calculated at 709. For example, a dot product between the encoded hypervector and a class hyper vector for class 1 is calculated, a dot product between the encoded hypervector and a class hyper vector for class 2 is calculated, etc.

A determination of if the computed dot product for the class L is a match is made at 711. A match occurs when the computed dot product for the class has the highest value out of all of the computed dot products. Using the earlier example, if the class label is class 2, is the dot product for class 2 a match? If so, then the encoded hypervector is added to the class hypervector of the first memory module at 7013. In other words,

$${C}_{L}^{A} = {C}_{L}^{A} + H .$$

Note that acts 707-713 occur in the first memory module.

If there is no match for the label, then the encoded hypervector is passed to the second memory module and a determination is made of if the encoded hypervector is a first sample of the class L in the second memory module is made at 715.

When the encoded hypervector is the first for the class in the second memory module, the encoded hypervector is added to the class vector of the second memory module at 721. In other words,

$${C}_{L}^{B} = {C}_{L}^{B} + H .$$

When the encoded hypervector is not the first sample of the class (that is there is a class hypervector for the class that has a non-zero value), then a dot product between the encoded hypervector and each of the class hypervectors for the second memory module is calculated at 716. For example, a dot product between the encoded hypervector and a class hyper vector for class 1 is calculated, a dot product between the encoded hypervector and a class hyper vector for class 2 is calculated, etc.

A determination of if the computed dot product for the class L is a match is made at 717. A match occurs when the computed dot product for the class has the highest value out of all of the computed dot products. Using the earlier example, if the class label is class 2, is the dot product for class 2 a match? If there is a match, then the encoded hypervector is added to the class vector of the second memory module at 719. In other words,

$${C}_{L}^{B} = {C}_{L}^{B} + H .$$

If there is not a match, the class hypervectors of the first memory module are set to be a sum of the class hypervectors of the first memory module and the class hypervectors of the second memory module at 723. In other words,

$${C}^{A} = {C}^{A} + {C}^{B} .$$

The class hypervector of the second memory module is set to be the encoded hypervector and all other class vectors of the second memory module are set to zero 725.

A determination of if there is more data is made at 727. If not, then the training is done at 729. If there is more data, the next encoded hypervector and class indication is received at 705. Note that acts 715-727 occur in the second memory module in some examples.

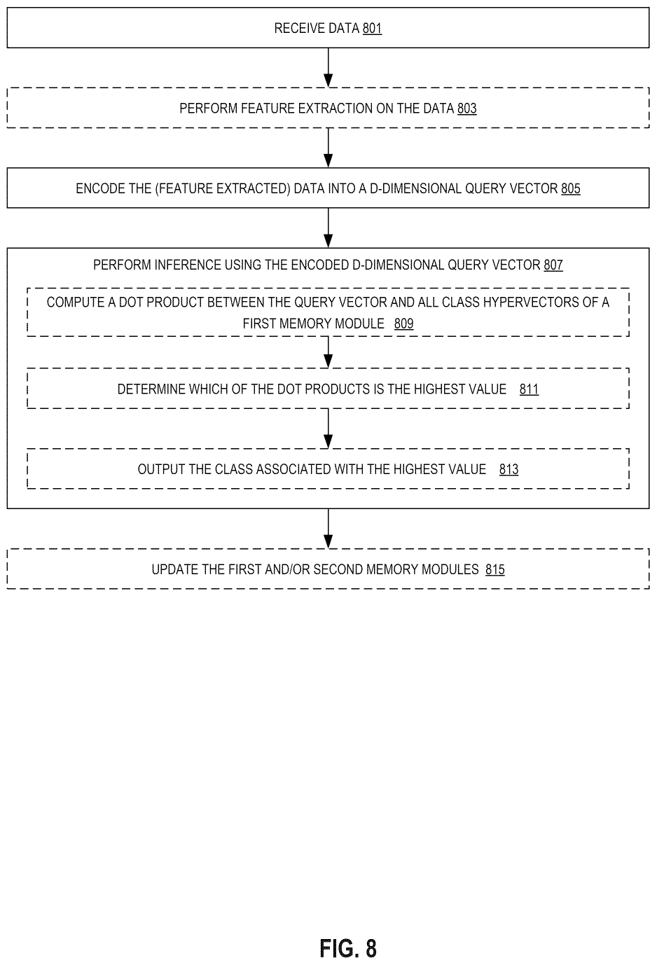

FIG. 8 illustrates a flow for performing inference using a trained HDC machine learning model. In some examples, this inference is in response to a request. For example, a request for a machine learning service of a cloud provider network. In some examples, the request includes at least one of an identifier of a HDC machine learning model to use for inference, an indication of a location for inference data, inference data, an indication of if feature extraction is to be performed, an indication of the feature extractor to use for feature extraction, etc. Inference is performed on using HDC inference 109 which comprises the first memory module 500.

In some examples, during inference, a query hypervector is matched against all the class hypervectors by computing a dot product between the query hypervector and all the class hypervectors in module A. The class corresponding to the highest dot product is selected as the prediction for the given query hypervector.

At 801 inference data is received.

In some examples, feature extraction is performed on the data at 803.

The (feature extracted) inference data is encoded into a d-dimensional query vector at 805.

Inference is performed using the encoded D-dimensional query vector at 807. In some examples, a dot product between the query vector and all class hypervectors of a first memory module is calculated at 809. For example, a dot product between the query vector and class hypervector 1 is calculated, a dot product between the query vector and class hypervector 2 is calculated, etc.

A determination of which of the dot products is the highest value (e.g., using an argument max (argmax) function) is made at 811 and a class associated with the highest value is output at 813.

In some examples, during inference, a similarity (e.g., cosine similarity) of the query hypervector and all the class hypervectors is computed. The class with the highest similarity is the prediction.

In some examples, the first and/or second memory modules at 815 using the training methodology described above where the predicted class is provided along with the query vector as the training data input.

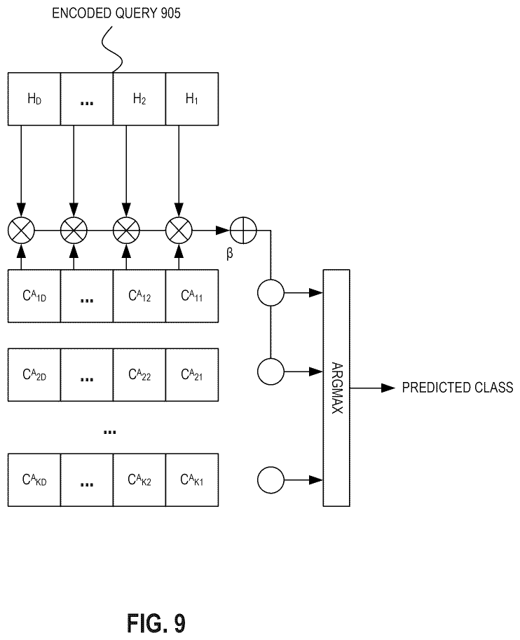

FIG. 9 illustrates examples of inference for HDC. As shown, only the first memory module is used for inference. An encoded query 905 and a dot product is performed using the encoded query 906 and all of the class hypervectors for the first memory module. An argument max (ARGMAX) function is applied to the dot product results to predict a class.

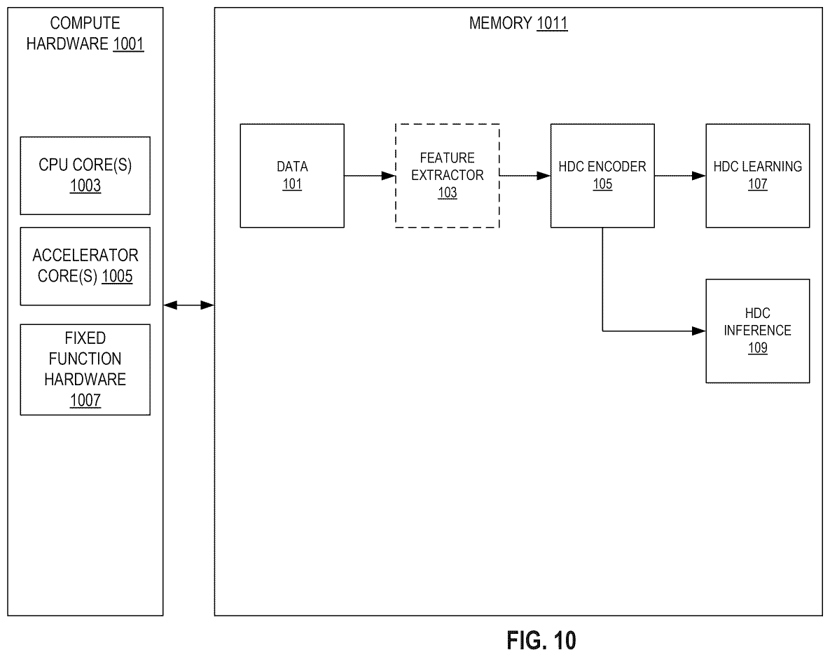

FIG. 10 illustrates examples of systems that support supervised learning using hyperdimensional computing. Computer hardware 1001 is used to perform machine learning training. In some examples, the compute hardware 1001 includes one or more central processing unit (CPU) core(s) 1003. In some examples, the CPU core(s) 1003 support(s) vector or single instruction, multiple data operations and scalar operations. In some examples, the CPU core(s) 1003 support(s) one or more data types such as 1-bit integer (in some examples, having values of −1, 0, or 1), 2-bit integer, 4-bit integer, 8-bit integer, 16-bit integer, 32-bit integer, 64-bit integer, 4-bit floating point (FP4-1 sign bit, 2-bit exponent, 1-bit fraction (1-2-1), or normal float (NF4)), 8-bit floating point (FP8 in either 1-4-3 or 1-5-2 format), 16-bit floating point (e.g., half-precision or brain floating 16 (BF16), 19-bit floating point, 32-bit floating point, 64-bit floating point, etc. In some examples, one or more of the CPU core(s) 1003 support(s) includes matrix hardware.

In some examples, the compute hardware 1001 includes one or more accelerator core(s) 1005 external to the CPU core(s) 1003. The accelerator core(s) 1005 may include one or more graphics processing unit (GPU) cores, field programmable gate array (FPGA) cores, application specific integrated circuits (ASICs), etc. In some examples, the accelerator core(s) 1005 support(s) one or more data types such as 1-bit integer (in some examples, having values of −1, 0, or 1), 2-bit integer, 4-bit integer, 8-bit integer, 16-bit integer, 32-bit integer, 64-bit integer, 4-bit floating point (FP4-1 sign bit, 2-bit exponent, 1-bit fraction (1-2-1), or normal float (NF4)), 8-bit floating point (FP8 in either 1-4-3 or 1-5-2 format), 16-bit floating point (e.g., half-precision or brain floating 16 (BF16), 19-bit floating point, 32-bit floating point, 64-bit floating point, etc.

In some examples, fixed-function hardware 1007 support(s) one or more data types such as 1-bit integer (in some examples, having values of −1, 0, or 1), 2-bit integer, 4-bit integer, 8-bit integer, 16-bit integer, 32-bit integer, 64-bit integer, 4-bit floating point (FP4-1 sign bit, 2-bit exponent, 1-bit fraction (1-2-1), or normal float (NF4)), 8-bit floating point (FP8 in either 1-4-3 or 1-5-2 format), 16-bit floating point (e.g., half-precision or brain floating 16 (BF16), 19-bit floating point, 32-bit floating point, 64-bit floating point, etc.

Memory 1011 coupled to the compute hardware 1001 is used to store one or more of training and/or inference data 101, a feature extractor 103, an HDC encoder 105, an HDC learning module 107 (e.g., the two memory modules detailed above), and an HDC inference module 109 (e.g., one of the two memory modules detailed above). Memory 1011 may include one or more of dynamic random access memory (DRAM), disk, solid-state memory, high bandwidth memory (HBM), etc.

In some examples, the compute hardware 1001 and memory 1011 are implemented in a field programmable gate array (FPGA).

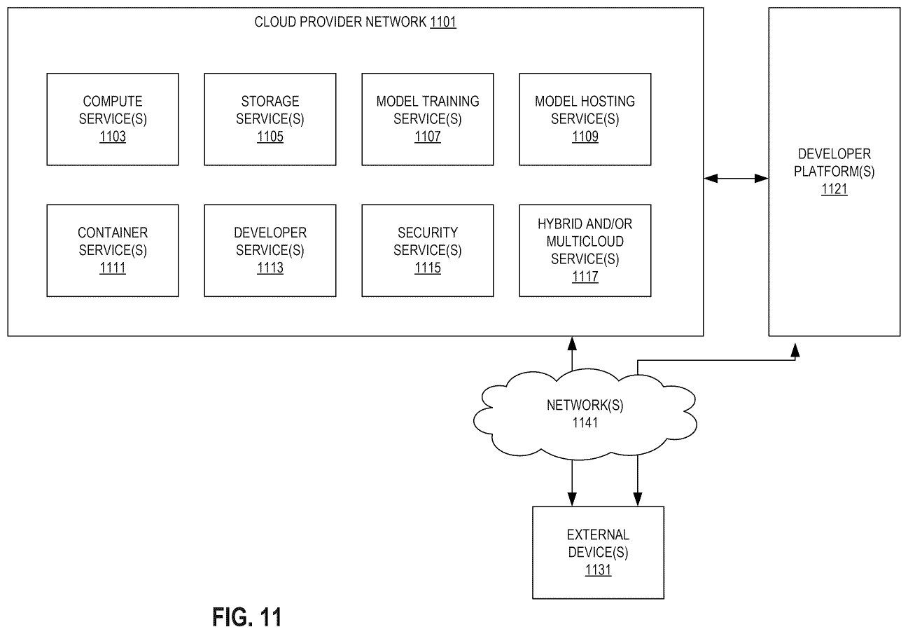

In some examples, a cloud provider network provides a service that allows for HDC training and/or inference as detailed above. FIG. 11 illustrates examples of a cloud provider network. The example cloud provider network 1101 includes a plurality of services.

In some examples, one or more compute services 1103 provide cloud compute capacity, virtualization, and scaling. In some examples, one or more of these services allows for the containerization of applications, deployment to virtual machines (VMs), etc. These compute services support a plurality of different instance types (e.g., CPU, GPU, accelerators, etc.) and/or memory support (e.g., an amount of RAM, etc.). In some examples, the compute services support a dedicated host, container hosting, a compute fleet, OS servers, etc.

In some examples, one or more storage services 1105 provide cloud storage. For example, these storage services may include databases, disk storage, blob storage, data lake storage, file syncing with on-premises data, container storage, etc.

In some examples, one or more model training services 1107 provide support for training of a ML model. In some examples, the HDC training described above is supported through a command line interface or graphical user interface input. The model training services support one or more of bot development, searching, model training, model validation, computer vision, etc.

In some examples, one or more model hosting services 1109 allow for a trained model to be deployed and hosted within the cloud provider network. For example, HDC inference may be supported using one of these services.

In some examples, one or more container services 1111 support the development and deployment of containerized software. In some examples, these services include a registry to build, store, secure, and/or replicate containers. In some examples, these services support storage for containers.

In some examples, one or more developer services 1113 support the development of code. For example, these services may provide an integrated development environment (IDE), code debugging, software development kits (SDKs), load testing, code generation, etc.

In some examples, one or more security services 1115 protect applications, data, and/or cloud infrastructure. These services may include threat protection, cryptographic key management, denial of service protection, information protection (e.g., protecting emails, documents, etc.), attestation of trusted execution environments, etc.

In some examples, one or more hybrid and/or multi-cloud services 1117 allow for the synchronization of cloud and on-premises directories, data, etc. These services may also provide for running local VMs, containers, and cloud provider network services.

Developer platform(s) 1121 allow for storage, editing, etc. of software development projects. In some examples, code for DNN training may be stored using a developer platform.

External device(s) 1131 connect to the cloud provider network 1101 and/or developer platform(s) 1121 through one or more networks 1141.

Examples detailed above may be implemented using one or more architectures, CPUs, GPUs, etc. Detailed below are examples of apparatuses, systems, systems-on-chip, etc. in which examples detailed above may be implemented.

### Example Architectures

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

### Example Systems

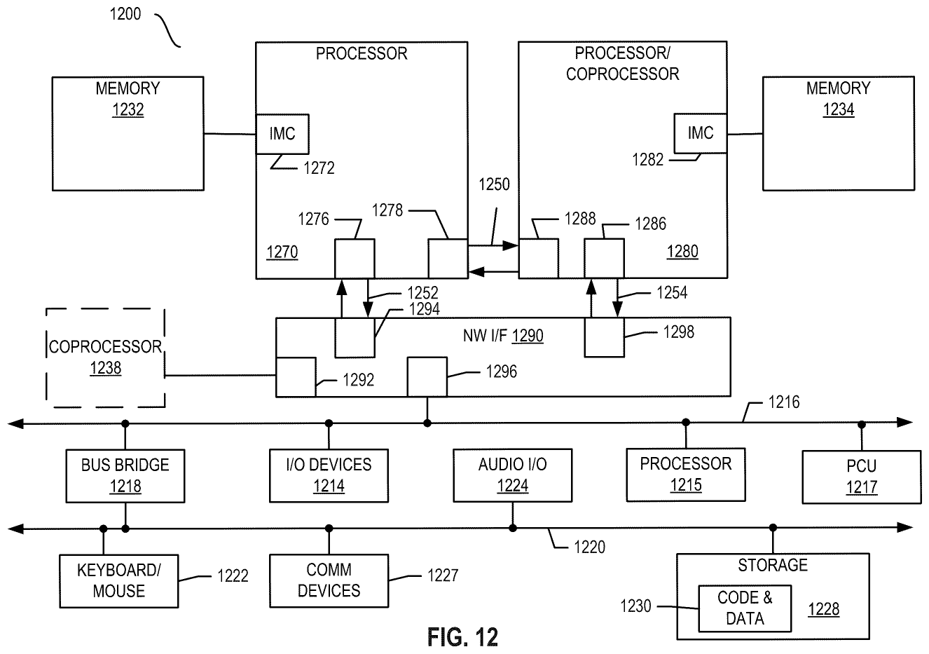

FIG. 12 illustrates an example computing system. Multiprocessor system 1200 is an interfaced system and includes a plurality of processors or cores including a first processor 1270 and a second processor 1280 coupled via an interface 1250 such as a point-to-point (P-P) interconnect, a fabric, and/or bus. In some examples, the first processor 1270 and the second processor 1280 are homogeneous. In some examples, first processor 1270 and the second processor 1280 are heterogenous. Though the example multiprocessor system 1200 is shown to have two processors, the system may have three or more processors, or may be a single processor system. In some examples, the computing system is a system on a chip (SoC).

Processors 1270 and 1280 are shown including integrated memory controller (IMC) circuitry 1272 and 1282, respectively. Processor 1270 also includes interface circuits 1276 and 1278; similarly, second processor 1280 includes interface circuits 1286 and 1288. Processors 1270, 1280 may exchange information via the interface 1250 using interface circuits 1278, 1288. IMCs 1272 and 1282 couple the processors 1270, 1280 to respective memories, namely a memory 1232 and a memory 1234, which may be portions of main memory locally attached to the respective processors.

Processors 1270, 1280 may each exchange information with a network interface (NW I/F) 1290 via individual interfaces 1252, 1254 using interface circuits 1276, 1294, 1286, 1298. The network interface 1290 (e.g., one or more of an interconnect, bus, and/or fabric, and in some examples is a chipset) may optionally exchange information with a co-processor 1238 via an interface circuit 1292. In some examples, the co-processor 1238 is a special-purpose processor, such as, for example, a high-throughput processor, a network or communication processor, a compression engine, a graphics processor, a general purpose graphics processing unit (GPGPU), a neural-network processing unit (NPU), an embedded processor, a security processor, a cryptographic accelerator, a matrix accelerator, an in-memory analytics accelerator, a data streaming accelerator, data graph operations, or the like.

A shared cache (not shown) may be included in either processor 1270, 1280 or outside of both processors, yet connected with the processors via an interface such as P-P interconnect, such that either or both processors' local cache information may be stored in the shared cache if a processor is placed into a low power mode.

Network interface 1290 may be coupled to a first interface 1216 via interface circuit 1296. In some examples, first interface 1216 may be an interface such as a Peripheral Component Interconnect (PCI) interconnect, a PCI Express interconnect or another I/O interconnect. In some examples, first interface 1216 is coupled to a power control unit (PCU) 1217, which may include circuitry, software, and/or firmware to perform power management operations with regard to the processors 1270, 1280 and/or co-processor 1238. PCU 1217 provides control information to a voltage regulator (not shown) to cause the voltage regulator to generate the appropriate regulated voltage. PCU 1217 also provides control information to control the operating voltage generated. In various examples, PCU 1217 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1217 is illustrated as being present as logic separate from the processor 1270 and/or processor 1280. In other cases, PCU 1217 may execute on a given one or more of cores (not shown) of processor 1270 or 1280. In some cases, PCU 1217 may be implemented as a microcontroller (dedicated or general-purpose) or other control logic configured to execute its own dedicated power management code, sometimes referred to as P-code. In yet other examples, power management operations to be performed by PCU 1217 may be implemented externally to a processor, such as by way of a separate power management integrated circuit (PMIC) or another component external to the processor. In yet other examples, power management operations to be performed by PCU 1217 may be implemented within BIOS or other system software.

Various I/O devices 1214 may be coupled to first interface 1216, along with a bus bridge 1218 which couples first interface 1216 to a second interface 1220. In some examples, one or more additional processor(s) 1215, such as co-processors, high throughput many integrated core (MIC) processors, GPGPUs, accelerators (such as graphics accelerators or digital signal processing (DSP) units), field programmable gate arrays (FPGAs), or any other processor, are coupled to first interface 1216. In some examples, second interface 1220 may be a low pin count (LPC) interface. Various devices may be coupled to second interface 1220 including, for example, a keyboard and/or mouse 1222, communication devices 1227 and storage circuitry 1228. Storage circuitry 1228 may be one or more non-transitory machine-readable storage media as described below, such as a disk drive or other mass storage device which may include instructions/code and data 1230 and may implement the storage ‘ISAB03 in some examples. Further, an audio I/O 1224 may be coupled to second interface 1220. Note that other architectures than the point-to-point architecture described above are possible. For example, instead of the point-to-point architecture, a system such as multiprocessor system 1200 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a co-processor including one or more special purpose cores intended primarily for graphics and/or scientific (throughput) computing. Such different processors lead to different computer system architectures, which may include: 1) the co-processor on a separate chip from the CPU; 2) the co-processor on a separate die in the same package as a CPU; 3) the co-processor on the same die as a CPU (in which case, such a co-processor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described co-processor, and additional functionality. Example core architectures are described next, followed by descriptions of example processors and computer architectures.

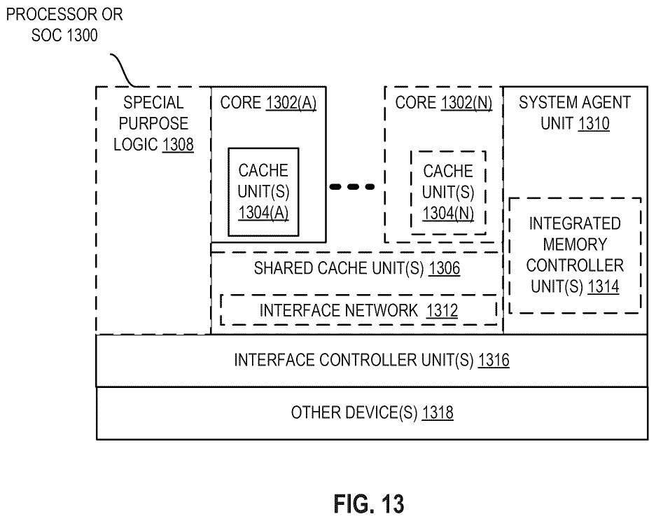

FIG. 13 illustrates a block diagram of an example processor and/or SoC 1300 that may have one or more cores and an integrated memory controller. The solid lined boxes illustrate a processor and/or SoC 1300 with a single core 1302(A), system agent unit circuitry 1310, and a set of one or more interface controller unit(s) circuitry 1316, while the optional addition of the dashed lined boxes illustrates an alternative processor and/or SoC 1300 with multiple cores 1302(A)-(N), a set of one or more integrated memory controller unit(s) circuitry 1314 in the system agent unit circuitry 1310, and special purpose logic 1308, as well as a set of one or more interface controller unit(s) circuitry 1316. Note that the processor and/or SoC 1300 may be one of the processors 1270 or 1280, or co-processor 1238 or 1215 of FIG. 12.

Thus, different implementations of the processor and/or SoC 1300 may include: 1) a CPU with the special purpose logic 1308 being a high-throughput processor, a network or communication processor, a compression engine, a graphics processor, a general purpose graphics processing unit (GPGPU), a neural-network processing unit (NPU), an embedded processor, a security processor, a matrix accelerator, an in-memory analytics accelerator, a compression accelerator, a data streaming accelerator, data graph operations, or the like (which may include one or more cores, not shown), and the cores 1302(A)-(N) being one or more general purpose cores (e.g., general purpose in-order cores, general purpose out-of-order cores, or a combination of the two); 2) a co-processor with the cores 1302(A)-(N) being a large number of special purpose cores intended primarily for graphics and/or scientific (throughput); and 3) a co-processor with the cores 1302(A)-(N) being a large number of general purpose in-order cores. Thus, the processor and/or SoC 1300 may be a general-purpose processor, co-processor or special-purpose processor, such as, for example, a network or communication processor, compression engine, graphics processor, GPGPU (general purpose graphics processing unit), a high throughput many integrated core (MIC) co-processor (including 30 or more cores), embedded processor, or the like. The processor may be implemented on one or more chips. The processor and/or SoC 1300 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1304(A)-(N) within the cores 1302(A)-(N), a set of one or more shared cache unit(s) circuitry 1306, and external memory (not shown) coupled to the set of integrated memory controller unit(s) circuitry 1314. The set of one or more shared cache unit(s) circuitry 1306 may include one or more mid-level caches, such as level 2 (L2), level 3 (L3), level 4 (L4), or other levels of cache, such as a last level cache (LLC), and/or combinations thereof. While in some examples interface network circuitry 1312 (e.g., a ring interconnect) interfaces the special purpose logic 1308 (e.g., integrated graphics logic), the set of shared cache unit(s) circuitry 1306, and the system agent unit circuitry 1310, alternative examples use any number of well-known techniques for interfacing such units. In some examples, coherency is maintained between one or more of the shared cache unit(s) circuitry 1306 and cores 1302(A)-(N). In some examples, interface controller unit(s) circuitry 1316 couple the cores 1302(A)-(N) to one or more other devices 1318 such as one or more I/O devices, storage, one or more communication devices (e.g., wireless networking, wired networking, etc.), etc.

In some examples, one or more of the cores 1302(A)-(N) are capable of multi-threading. The system agent unit circuitry 1310 includes those components coordinating and operating cores 1302(A)-(N). The system agent unit circuitry 1310 may include, for example, power control unit (PCU) circuitry and/or display unit circuitry (not shown). The PCU may be or may include logic and components needed for regulating the power state of the cores 1302(A)-(N) and/or the special purpose logic 1308 (e.g., integrated graphics logic). The display unit circuitry is for driving one or more externally connected displays.

The cores 1302(A)-(N) may be homogenous in terms of instruction set architecture (ISA). Alternatively, the cores 1302(A)-(N) may be heterogeneous in terms of ISA; that is, a subset of the cores 1302(A)-(N) may be capable of executing an ISA, while other cores may be capable of executing only a subset of that ISA or another ISA.

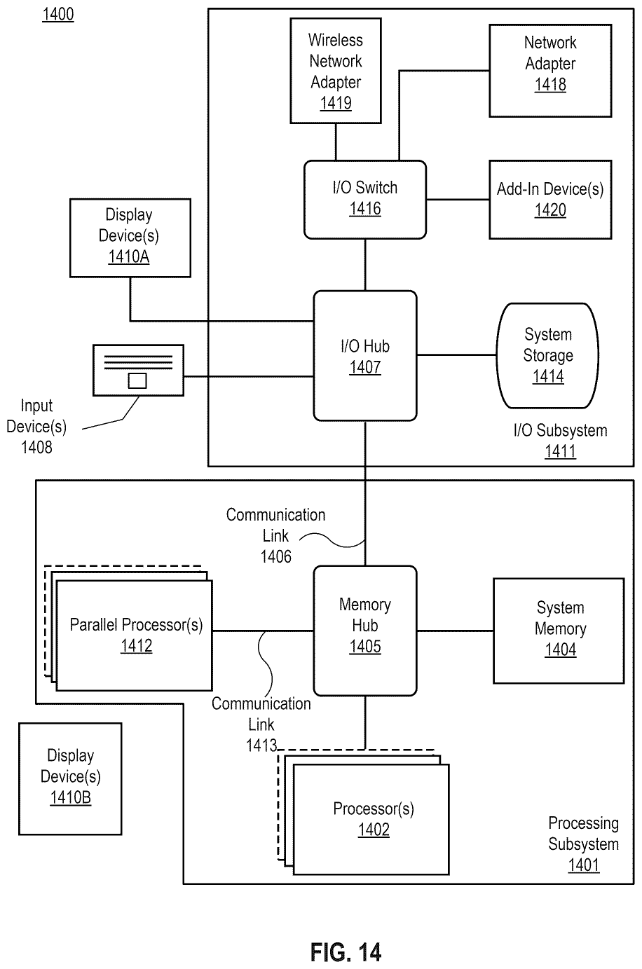

FIG. 14 is a block diagram illustrating a computing system 1400 configured to implement one or more aspects of the examples described herein. The computing system 1400 includes a processing subsystem 1401 having one or more processor(s) 1402 and a system memory 1404 communicating via an interconnection path that may include a memory hub 1405. The memory hub 1405 may be a separate component within a chipset component or may be integrated within the one or more processor(s) 1402. The memory hub 1405 couples with an I/O subsystem 1411 via a communication link 1406. The I/O subsystem 1411 includes an I/O hub 1407 that can enable the computing system 1400 to receive input from one or more input device(s) 1408. Additionally, the I/O hub 1407 can enable a display controller, which may be included in the one or more processor(s) 1402, to provide outputs to one or more display device(s) 1410A. In some examples the one or more display device(s) 1410A coupled with the I/O hub 1407 can include a local, internal, or embedded display device.

The processing subsystem 1401, for example, includes one or more parallel processor(s) 1412 coupled to memory hub 1405 via a bus or communication link 1413. The communication link 1413 may be one of any number of standards-based communication link technologies or protocols, such as, but not limited to PCI Express, or may be a vendor specific communications interface or communications fabric. The one or more parallel processor(s) 1412 may form a computationally focused parallel or vector processing system that can include a large number of processing cores and/or processing clusters, such as a many integrated core (MIC) processor. For example, the one or more parallel processor(s) 1412 form a graphics processing subsystem that can output pixels to one of the one or more display device(s) 1410A coupled via the I/O hub 1407. The one or more parallel processor(s) 1412 can also include a display controller and display interface (not shown) to enable a direct connection to one or more display device(s) 1410B.

Within the I/O subsystem 1411, a system storage unit 1414 can connect to the I/O hub 1407 to provide a storage mechanism for the computing system 1400. An I/O switch 1416 can be used to provide an interface mechanism to enable connections between the I/O hub 1407 and other components, such as a network adapter 1418 and/or wireless network adapter 1419 that may be integrated into the platform, and various other devices that can be added via one or more add-in device(s) 1420. The add-in device(s) 1420 may also include, for example, one or more external graphics processor devices, graphics cards, and/or compute accelerators. The network adapter 1418 can be an Ethernet adapter or another wired network adapter. The wireless network adapter 1419 can include one or more of a Wi-Fi, Bluetooth, near field communication (NFC), or other network device that includes one or more wireless radios.

The computing system 1400 can include other components not explicitly shown, including USB or other port connections, optical storage drives, video capture devices, and the like, which may also be connected to the I/O hub 1407. Communication paths interconnecting the various components in FIG. 14 may be implemented using any suitable protocols, such as PCI (Peripheral Component Interconnect) based protocols (e.g., PCI-Express), or any other bus or point-to-point communication interfaces and/or protocol(s), such as the NVLink high-speed interconnect, Compute Express Link™ (CXL™) (e.g., CXL.mem), Infinity Fabric (IF), Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (ROCE), Intel QuickPath Interconnect (QPI), Intel Ultra Path Interconnect (UPI), Intel On-Chip System Fabric (IOSF), Omnipath, HyperTransport, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof, or wired or wireless interconnect protocols known in the art. In some examples, data can be copied or stored to virtualized storage nodes using a protocol such as non-volatile memory express (NVMe) over Fabrics (NVMe-oF) or NVMe.

The one or more parallel processor(s) 1412 may incorporate circuitry optimized for graphics and video processing, including, for example, video output circuitry, and constitutes a graphics processing unit (GPU). Alternatively or additionally, the one or more parallel processor(s) 1412 can incorporate circuitry optimized for general purpose processing, while preserving the underlying computational architecture, described in greater detail herein. Components of the computing system 1400 may be integrated with one or more other system elements on a single integrated circuit. For example, the one or more parallel processor(s) 1412, memory hub 1405, processor(s) 1402, and I/O hub 1407 can be integrated into a system on chip (SoC) integrated circuit. Alternatively, the components of the computing system 1400 can be integrated into a single package to form a system in package (SIP) configuration. In some examples at least a portion of the components of the computing system 1400 can be integrated into a multi-chip module (MCM), which can be interconnected with other multi-chip modules into a modular computing system.

It will be appreciated that the computing system 1400 shown herein is illustrative and that variations and modifications are possible. The connection topology, including the number and arrangement of bridges, the number of processor(s) 1402, and the number of parallel processor(s) 1412, may be modified as desired. For instance, system memory 1404 can be connected to the processor(s) 1402 directly rather than through a bridge, while other devices communicate with system memory 1404 via the memory hub 1405 and the processor(s) 1402. In other alternative topologies, the parallel processor(s) 1412 are connected to the I/O hub 1407 or directly to one of the one or more processor(s) 1402, rather than to the memory hub 1405. In other examples, the I/O hub 1407 and memory hub 1405 may be integrated into a single chip. It is also possible that two or more sets of processor(s) 1402 are attached via multiple sockets, which can couple with two or more instances of the parallel processor(s) 1412.

Some of the particular components shown herein are optional and may not be included in all implementations of the computing system 1400. For example, any number of add-in cards or peripherals may be supported, or some components may be eliminated. Furthermore, some architectures may use different terminology for components similar to those illustrated in FIG. 14. For example, the memory hub 1405 may be referred to as a Northbridge in some architectures, while the I/O hub 1407 may be referred to as a Southbridge.

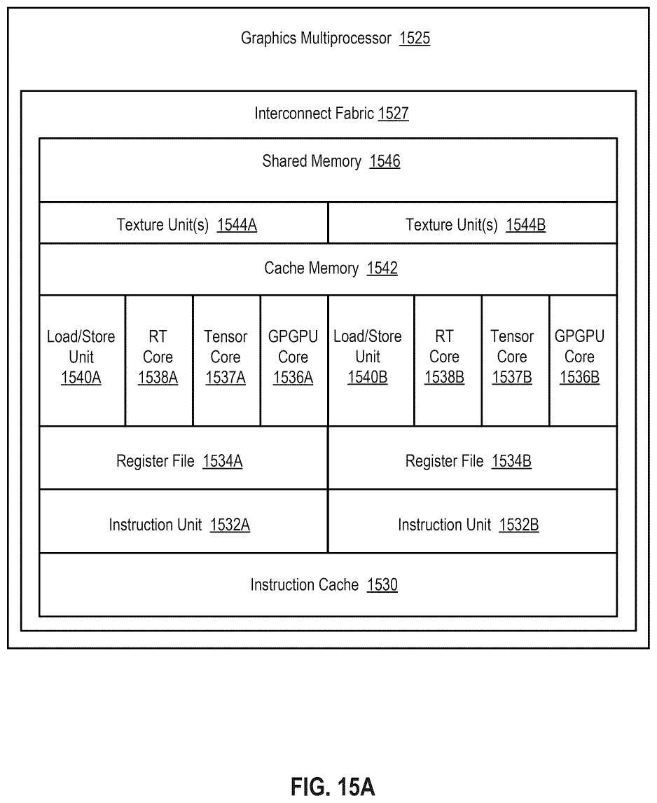

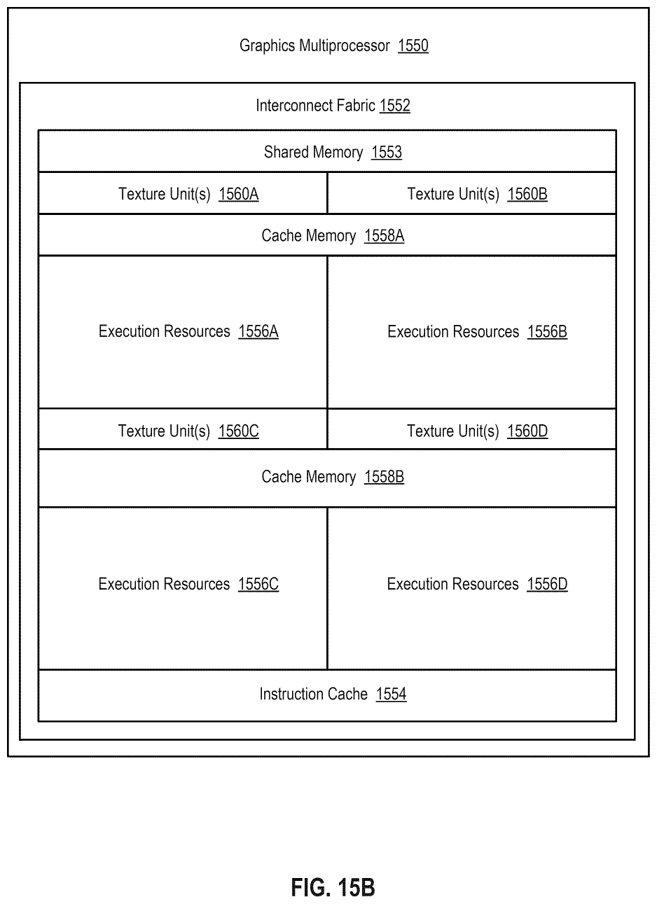

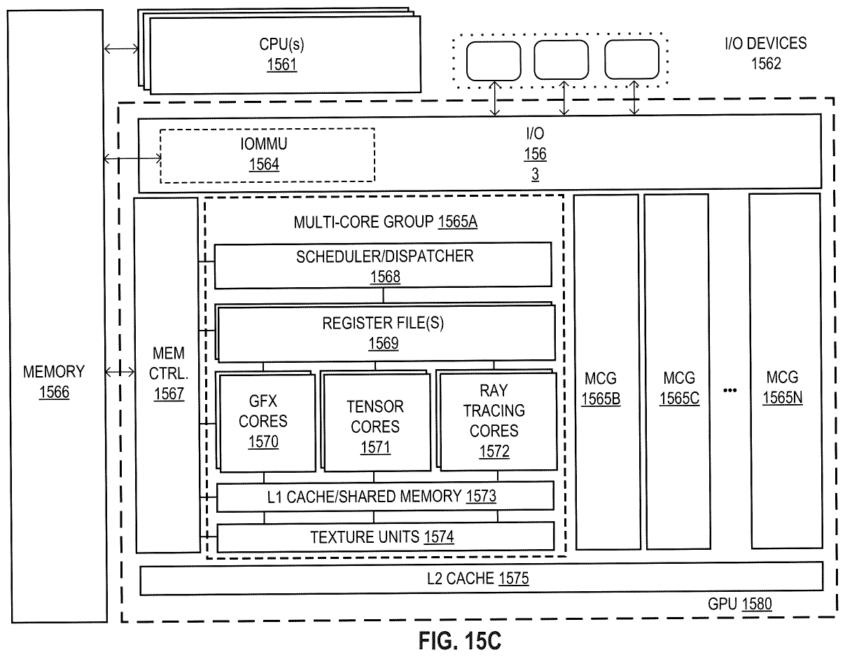

FIGS. 15A-15C illustrate additional graphics multiprocessors, according to examples. FIG. 15A-15B illustrate graphics multiprocessors 1525, 1550. FIG. 15C illustrates a graphics processing unit (GPU) 1580 which includes dedicated sets of graphics processing resources arranged into multi-core groups 1565A-1565N, which correspond to the graphics multiprocessors 1525, 1550. The illustrated graphics multiprocessors 1525, 1550 and the multi-core groups 1565A-1565N can be streaming multiprocessors (SM) capable of simultaneous execution of a large number of execution threads.

The graphics multiprocessor 1525 of FIG. 15A includes multiple instances of execution resource units. For example, the graphics multiprocessor 1525 can include multiple instances of the instruction unit 1532A-1532B, register file 1534A-1534B, and texture unit(s) 1544A-1544B. The graphics multiprocessor 1525 also includes multiple sets of graphics or compute execution units (e.g., GPGPU core 1536A-1536B, tensor core 1537A-1537B, ray-tracing core 1538A-1538B) and multiple sets of load/store units 1540A-1540B. The execution resource units have a common instruction cache 1530, texture and/or data cache memory 1542, and shared memory 1546.

The various components can communicate via an interconnect fabric 1527. The interconnect fabric 1527 may include one or more crossbar switches to enable communication between the various components of the graphics multiprocessor 1525. The interconnect fabric 1527 may be a separate, high-speed network fabric layer upon which each component of the graphics multiprocessor 1525 is stacked. The components of the graphics multiprocessor 1525 communicate with remote components via the interconnect fabric 1527. For example, the cores 1536A-1536B, 1537A-1537B, and 1538A-1538B can each communicate with shared memory 1546 via the interconnect fabric 1527. The interconnect fabric 1527 can arbitrate communication within the graphics multiprocessor 1525 to ensure a fair bandwidth allocation between components.

The graphics multiprocessor 1550 of FIG. 15B includes multiple sets of execution resources 1556A-1556D, where each set of execution resource includes multiple instruction units, register files, GPGPU cores, and load store units, as illustrated in FIG. 15A. The execution resources 1556A-1556D can work in concert with texture unit(s) 1560A-1560D for texture operations, while sharing an instruction cache 1554, and shared memory 1553. For example, the execution resources 1556A-1556D can share an instruction cache 1554 and shared memory 1553, as well as multiple instances of a texture and/or data cache memory 1558A-1558B. The various components can communicate via an interconnect fabric 1552 similar to the interconnect fabric 1527 of FIG. 15A.

The parallel processor or GPGPU as described herein may be communicatively coupled to host/processor cores to accelerate graphics operations, machine-learning operations, pattern analysis operations, and various general-purpose GPU (GPGPU) functions. The GPU may be communicatively coupled to the host processor/cores over a bus or other interconnect (e.g., a high-speed interconnect such as PCIe, NVLink, or other known protocols, standardized protocols, or proprietary protocols). In other examples, the GPU may be integrated on the same package or chip as the cores and communicatively coupled to the cores over an internal processor bus/interconnect (i.e., internal to the package or chip). Regardless of the manner in which the GPU is connected, the processor cores may allocate work to the GPU in the form of sequences of commands/instructions contained in a work descriptor. The GPU then uses dedicated circuitry/logic for efficiently processing these commands/instructions.

FIG. 15C illustrates a graphics processing unit (GPU) 1580 which includes dedicated sets of graphics processing resources arranged into multi-core groups 1565A-1565N. While the details of only a single multi-core group 1565A are provided, it will be appreciated that the other multi-core groups 1565B-1565N may be equipped with the same or similar sets of graphics processing resources. Details described with respect to the multi-core groups 1565A-1565N may also apply to any graphics multiprocessor.

As illustrated, a multi-core group 1565A may include a set of graphics cores 1570, a set of tensor cores 1571, and a set of ray tracing cores 1572. A scheduler/dispatcher 1568 schedules and dispatches the graphics threads for execution on the various cores 1570, 1571, 1572. A set of register files 1569 store operand values used by the cores 1570, 1571, 1572 when executing the graphics threads. These may include, for example, integer registers for storing integer values, floating point registers for storing floating point values, vector registers for storing packed data elements (integer and/or floating-point data elements) and tile registers for storing tensor/matrix values. The tile registers may be implemented as combined sets of vector registers.

One or more combined level 1 (L1) caches and shared memory units 1573 store graphics data such as texture data, vertex data, pixel data, ray data, bounding volume data, etc., locally within each multi-core group 1565A. One or more texture units 1574 can also be used to perform texturing operations, such as texture mapping and sampling. A Level 2 (L2) cache 1575 shared by all or a subset of the multi-core groups 1565A-1565N stores graphics data and/or instructions for multiple concurrent graphics threads. As illustrated, the L2 cache 1575 may be shared across a plurality of multi-core groups 1565A-1565N. One or more memory controllers 1567 couple the GPU 1580 to a memory 1566 which may be a system memory (e.g., DRAM) and/or a dedicated graphics memory (e.g., GDDR6 memory).

Input/output (I/O) circuitry 1563 couples the GPU 1580 to one or more I/O devices 1562 such as digital signal processors (DSPs), network controllers, or user input devices. An on-chip interconnect may be used to couple the I/O devices 1562 to the GPU 1580 and memory 1566. One or more I/O memory management units (IOMMUs) 1564 of the I/O circuitry 1563 couple the I/O devices 1562 directly to the system memory 1566. Optionally, the IOMMU 1564 manages multiple sets of page tables to map virtual addresses to physical addresses in system memory 1566. The I/O devices 1562, CPU(s) 1561, and GPU(s) 1580 may then share the same virtual address space.

In one implementation of the IOMMU 1564, the IOMMU 1564 supports virtualization. In this case, it may manage a first set of page tables to map guest/graphics virtual addresses to guest/graphics physical addresses and a second set of page tables to map the guest/graphics physical addresses to system/host physical addresses (e.g., within system memory 1566). The base addresses of each of the first and second sets of page tables may be stored in control registers and swapped out on a context switch (e.g., so that the new context is provided with access to the relevant set of page tables). While not illustrated in FIG. 15C, each of the cores 1570, 1571, 1572 and/or multi-core groups 1565A-1565N may include translation lookaside buffers (TLBs) to cache guest virtual to guest physical translations, guest physical to host physical translations, and guest virtual to host physical translations.

The CPU(s) 1561, GPUs 1580, and I/O devices 1562 may be integrated on a single semiconductor chip and/or chip package. The illustrated memory 1566 may be integrated on the same chip or may be coupled to the memory controllers 1567 via an off-chip interface. In one implementation, the memory 1566 comprises GDDR6 memory which shares the same virtual address space as other physical system-level memories, although the underlying principles described herein are not limited to this specific implementation.

The tensor cores 1571 may include a plurality of execution units specifically designed to perform matrix operations, which are the fundamental compute operation used to perform deep learning operations. For example, simultaneous matrix multiplication operations may be used for neural network training and inferencing. The tensor cores 1571 may perform matrix processing using a variety of operand precisions including single precision floating-point (e.g., 32 bits), half-precision floating point (e.g., 16 bits), integer words (16 bits), bytes (8 bits), and half-bytes (4 bits). For example, a neural network implementation extracts features of each rendered scene, potentially combining details from multiple frames, to construct a high-quality final image.

In deep learning implementations, parallel matrix multiplication work may be scheduled for execution on the tensor cores 1571. The training of neural networks, in particular, requires a significant number of matrix dot product operations. In order to process an inner-product formulation of an N×N×N matrix multiply, the tensor cores 1571 may include at least N dot-product processing elements. Before the matrix multiply begins, one entire matrix is loaded into tile registers and at least one column of a second matrix is loaded each cycle for N cycles. Each cycle, there are N dot products that are processed.

Matrix elements may be stored at different precisions depending on the particular implementation, including 16-bit words, 8-bit bytes (e.g., INT8) and 4-bit half-bytes (e.g., INT4). Different precision modes may be specified for the tensor cores 1571 to ensure that the most efficient precision is used for different workloads (e.g., such as inferencing workloads which can tolerate quantization to bytes and half-bytes). Supported formats additionally include 64-bit floating point (FP64) and non-IEEE floating point formats such as the bfloat16 format (e.g., Brain floating point), a 16-bit floating point format with one sign bit, eight exponent bits, and eight significand bits, of which seven are explicitly stored. One example includes support for a reduced precision tensor-float (TF32) mode, which performs computations using the range of FP32 (8-bits) and the precision of FP16 (10-bits). Reduced precision TF32 operations can be performed on FP32 inputs and produce FP32 outputs at higher performance relative to FP32 and increased precision relative to FP16. In some examples, one or more 8-bit floating point formats (FP8) are supported.

In some examples the tensor cores 1571 support a sparse mode of operation for matrices in which the vast majority of values are zero. The tensor cores 1571 include support for sparse input matrices that are encoded in a sparse matrix representation (e.g., coordinate list encoding (COO), compressed sparse row (CSR), compress sparse column (CSC), etc.). The tensor cores 1571 also include support for compressed sparse matrix representations in the event that the sparse matrix representation may be further compressed. Compressed, encoded, and/or compressed and encoded matrix data, along with associated compression and/or encoding metadata, can be read by the tensor cores 1571 and the non-zero values can be extracted. For example, for a given input matrix A, a non-zero value can be loaded from the compressed and/or encoded representation of at least a portion of matrix A. Based on the location in matrix A for the non-zero value, which may be determined from index or coordinate metadata associated with the non-zero value, a corresponding value in input matrix B may be loaded. Depending on the operation to be performed (e.g., multiply), the load of the value from input matrix B may be bypassed if the corresponding value is a zero value. In some examples, the pairings of values for certain operations, such as multiply operations, may be pre-scanned by scheduler logic and only operations between non-zero inputs are scheduled. Depending on the dimensions of matrix A and matrix B and the operation to be performed, output matrix C may be dense or sparse. Where output matrix C is sparse and depending on the configuration of the tensor cores 1571, output matrix C may be output in a compressed format, a sparse encoding, or a compressed sparse encoding.

The ray tracing cores 1572 may accelerate ray tracing operations for both real-time ray tracing and non-real-time ray tracing implementations. In particular, the ray tracing cores 1572 may include ray traversal/intersection circuitry for performing ray traversal using bounding volume hierarchies (BVHs) and identifying intersections between rays and primitives enclosed within the BVH volumes. The ray tracing cores 1572 may also include circuitry for performing depth testing and culling (e.g., using a Z buffer or similar arrangement). In one implementation, the ray tracing cores 1572 perform traversal and intersection operations in concert with the image denoising techniques described herein, at least a portion of which may be executed on the tensor cores 1571. For example, the tensor cores 1571 may implement a deep learning neural network to perform denoising of frames generated by the ray tracing cores 1572. However, the CPU(s) 1561, graphics cores 1570, and/or ray tracing cores 1572 may also implement all or a portion of the denoising and/or deep learning algorithms.

In addition, as described above, a distributed approach to denoising may be employed in which the GPU 1580 is in a computing device coupled to other computing devices over a network or high-speed interconnect. In this distributed approach, the interconnected computing devices may share neural network learning/training data to improve the speed with which the overall system learns to perform denoising for different types of image frames and/or different graphics applications.

The ray tracing cores 1572 may process all BVH traversal and/or ray-primitive intersections, saving the graphics cores 1570 from being overloaded with thousands of instructions per ray. For example, each ray tracing core 1572 includes a first set of specialized circuitry for performing bounding box tests (e.g., for traversal operations) and/or a second set of specialized circuitry for performing the ray-triangle intersection tests (e.g., intersecting rays which have been traversed). Thus, for example, the multi-core group 1565A can simply launch a ray probe, and the ray tracing cores 1572 independently perform ray traversal and intersection and return hit data (e.g., a hit, no hit, multiple hits, etc.) to the thread context. The other cores 1570, 1571 are freed to perform other graphics or compute work while the ray tracing cores 1572 perform the traversal and intersection operations.

Optionally, each ray tracing core 1572 may include a traversal unit to perform BVH testing operations and/or an intersection unit which performs ray-primitive intersection tests. The intersection unit generates a “hit”, “no hit”, or “multiple hit” response, which it provides to the appropriate thread. During the traversal and intersection operations, the execution resources of the other cores (e.g., graphics cores 1570 and tensor cores 1571) are freed to perform other forms of graphics work.

In some examples described below, a hybrid rasterization/ray tracing approach is used in which work is distributed between the graphics cores 1570 and ray tracing cores 1572.

The ray tracing cores 1572 (and/or other cores 1570, 1571) may include hardware support for a ray tracing instruction set such as Microsoft's DirectX Ray Tracing (DXR) which includes a DispatchRays command, as well as ray-generation, closest-hit, any-hit, and miss shaders, which enable the assignment of unique sets of shaders and textures for each object. Another ray tracing platform which may be supported by the ray tracing cores 1572, graphics cores 1570 and tensor cores 1571 is Vulkan API (e.g., Vulkan version 1.1.85 and later). Note, however, that the underlying principles described herein are not limited to any particular ray tracing ISA.

In general, the various cores 1572, 1571, 1570 may support a ray tracing instruction set that includes instructions/functions for one or more of ray generation, closest hit, any hit, ray-primitive intersection, per-primitive and hierarchical bounding box construction, miss, visit, and exceptions. More specifically, some examples includes ray tracing instructions to perform one or more of the following functions:
Ray Generation—Ray generation instructions may be executed for each pixel, sample, or other user-defined work assignment.
Closest Hit—A closest hit instruction may be executed to locate the closest intersection point of a ray with primitives within a scene.
Any Hit—An any hit instruction identifies multiple intersections between a ray and primitives within a scene, potentially to identify a new closest intersection point.
Intersection—An intersection instruction performs a ray-primitive intersection test and outputs a result.
Per-primitive Bounding box Construction—This instruction builds a bounding box around a given primitive or group of primitives (e.g., when building a new BVH or other acceleration data structure).
Miss—Indicates that a ray misses all geometry within a scene, or specified region of a scene.
Visit—Indicates the child volumes a ray will traverse.
Exceptions—Includes various types of exception handlers (e.g., invoked for various error conditions).

In some examples the ray tracing cores 1572 may be adapted to accelerate general-purpose compute operations that can be accelerated using computational techniques that are analogous to ray intersection tests. A compute framework can be provided that enables shader programs to be compiled into low level instructions and/or primitives that perform general-purpose compute operations via the ray tracing cores. Exemplary computational problems that can benefit from compute operations performed on the ray tracing cores 1572 include computations involving beam, wave, ray, or particle propagation within a coordinate space. Interactions associated with that propagation can be computed relative to a geometry or mesh within the coordinate space. For example, computations associated with electromagnetic signal propagation through an environment can be accelerated via the use of instructions or primitives that are executed via the ray tracing cores. Diffraction and reflection of the signals by objects in the environment can be computed as direct ray-tracing analogies.

Ray tracing cores 1572 can also be used to perform computations that are not directly analogous to ray tracing. For example, mesh projection, mesh refinement, and volume sampling computations can be accelerated using the ray tracing cores 1572. Generic coordinate space calculations, such as nearest neighbor calculations can also be performed. For example, the set of points near a given point can be discovered by defining a bounding box in the coordinate space around the point. BVH and ray probe logic within the ray tracing cores 1572 can then be used to determine the set of point intersections within the bounding box. The intersections constitute the origin point and the nearest neighbors to that origin point. Computations that are performed using the ray tracing cores 1572 can be performed in parallel with computations performed on the graphics cores 1572 and tensor cores 1571. A shader compiler can be configured to compile a compute shader or other general-purpose graphics processing program into low level primitives that can be parallelized across the graphics cores 1570, tensor cores 1571, and ray tracing cores 1572.

Building larger and larger silicon dies is challenging for a variety of reasons. As silicon dies become larger, manufacturing yields become smaller and process technology requirements for different components may diverge. On the other hand, in order to have a high-performance system, key components should be interconnected by high speed, high bandwidth, low latency interfaces. These contradicting needs pose a challenge to high performance chip development.

Embodiments described herein provide techniques to disaggregate an architecture of a system on a chip integrated circuit into multiple distinct chiplets that can be packaged onto a common chassis. In some examples, a graphics processing unit or parallel processor is composed from diverse silicon chiplets that are separately manufactured. A chiplet is an at least partially packaged integrated circuit that includes distinct units of logic that can be assembled with other chiplets into a larger package. A diverse set of chiplets with different IP core logic can be assembled into a single device. Additionally the chiplets can be integrated into a base die or base chiplet using active interposer technology. The concepts described herein enable the interconnection and communication between the different forms of IP within the GPU. The development of IPs on different process may be mixed. This avoids the complexity of converging multiple IPs, especially on a large SoC with several flavors IPs, to the same process.

Enabling the use of multiple process technologies improves the time to market and provides a cost-effective way to create multiple product SKUs. For customers, this means getting products that are more tailored to their requirements in a cost effective and timely manner. Additionally, the disaggregated IPs are more amenable to being power gated independently, components that are not in use on a given workload can be powered off, reducing overall power consumption.

### IP Core Implementations

One or more aspects of at least some examples may be implemented by representative code stored on a machine-readable medium which represents and/or defines logic within an integrated circuit such as a processor. For example, the machine-readable medium may include instructions which represent various logic within the processor. When read by a machine, the instructions may cause the machine to fabricate the logic to perform the techniques described herein. Such representations, known as “IP cores,” are reusable units of logic for an integrated circuit that may be stored on a tangible, machine-readable medium as a hardware model that describes the structure of the integrated circuit. The hardware model may be supplied to various customers or manufacturing facilities, which load the hardware model on fabrication machines that manufacture the integrated circuit. The integrated circuit may be fabricated such that the circuit performs operations described in association with any of the examples described herein.

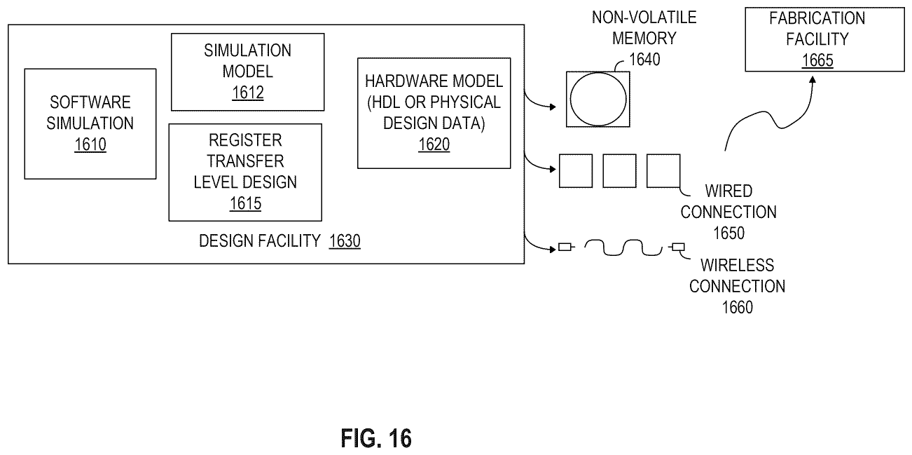

FIG. 16 is a block diagram illustrating an IP core development system 1600 that may be used to manufacture an integrated circuit to perform operations according to some examples. In some examples, aspects of embodiments detailed above may be implemented as an IP core. The IP core development system 1600 may be used to generate modular, re-usable designs that can be incorporated into a larger design or used to construct an entire integrated circuit (e.g., an SOC integrated circuit). A design facility 1630 can generate a software simulation 1610 of an IP core design in a high-level programming language (e.g., C/C++). The software simulation 1610 can be used to design, test, and verify the behavior of the IP core using a simulation model 1612. The simulation model 1612 may include functional, behavioral, and/or timing simulations. A register transfer level (RTL) design 1615 can then be created or synthesized from the simulation model 1612. The RTL design 1615 is an abstraction of the behavior of the integrated circuit that models the flow of digital signals between hardware registers, including the associated logic performed using the modeled digital signals. In addition to an RTL design 1615, lower-level designs at the logic level or transistor level may also be created, designed, or synthesized. Thus, the particular details of the initial design and simulation may vary.

The RTL design 1615 or equivalent may be further synthesized by the design facility into a hardware model 1620, which may be in a hardware description language (HDL), or some other representation of physical design data. The HDL may be further simulated or tested to verify the IP core design. The IP core design can be stored for delivery to a fabrication facility 1665 using non-volatile memory 1640 (e.g., hard disk, flash memory, or any non-volatile storage medium). Alternatively, the IP core design may be transmitted (e.g., via the Internet) over a wired connection 1650 or wireless connection 1660. The fabrication facility 1665 may then fabricate an integrated circuit that is based at least in part on the IP core design. The fabricated integrated circuit can be configured to perform operations in accordance with at least some examples described herein.

References to “some examples,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Examples include, but are not limited to:
1. A method comprising:
   receiving an encoded hypervector of a hyperdimensional computing (HDC) machine learning (ML) model and a class label for the encoded hypervector, the HDC ML model comprising a first learning module to store a first set of one or more class hypervectors and a second learning module to store a second set of one more class hypervectors, the second set of one or more class hypervectors being different from the first sect of one or more class hypervectors;
   evaluating the encoded hypervector using the first learning module by:
      when the encoded hypervector is a first sample of the class in the first learning module, adding the encoded hypervector to a class hypervector of the class of the first learning module, and
      when the encoded hypervector is not the first sample of the class in the first learning module:
         computing a dot product between the encoded hypervector and each class hypervector of the first set of one or more class hypervectors, and determining whether the computed dot product for the class is a match in the first learning module,
      when the computed dot product is a match, adding the encoded hypervector to a class hypervector of the class of the first learning module, and
      when the computed dot product is not a match evaluating the encoded hypervector using the second learning module.
2. The method of example 1, wherein evaluating the encoded hypervector using the second learning module comprises:
   when the encoded hypervector is a first sample of the class in the second learning module, adding the encoded hypervector to a class hypervector of the class of the second learning module, and
   when the encoded hypervector is not the first sample of the class in the second learning module,
      computing a dot product between the encoded hypervector and each class hypervector of the second set of one or more class hypervectors,
      determining whether the computed dot product for the class is a match in the second learning module,
      when the computed dot product is a match, adding the received encoded hypervector to a class hypervector of the class of the second learning module, and
      when the computed dot product is not a match, setting the class hypervectors of the first learning module to be a sum of the class hypervectors of the first learning module and the class hypervectors of the second learning module.
3. The method of example 2, further comprising:
   resetting the second learning module to zero when computed dot product is not a match in the second learning module.
4. The method of any of examples 1-3, further comprising:
   initializing all class hypervectors of the first learning module and the second learning module to zero.
5. The method of any of examples 1-3, wherein the computed dot product for the class is a match in the second learning module when the computed dot product for the class has a highest value of the computed dot products for the second set of one more class hypervectors.
6. The method of any of examples 1-5, further comprising:
   generating the encoded hypervector using a plurality of codebooks.
7. The method of any of examples 1-6, wherein the training is in response to a request received at a cloud provider network service wherein the request includes at least one of an identifier of the HDC ML model to train, an identifier of a HDC machine learning algorithm to train, an indication of a location for training data, an indication of a location for validation and/or testing data, an algorithm to use for encoding, or an indication of a compute instance to use for training.
8. A method comprising:
   encoding data into a query vector;
   performing the inference to predict a class for data using a hyperdimensional computing (HDC) machine learning (ML) model, wherein the HDC ML model comprises a first learning module to store a first set of one or more class hypervectors and a second learning module to store a second, different set of one or more class hypervectors, by:
      computing a dot product between the query vector and each class hypervector of a first memory module,
      determining which of the dot products has a highest value, wherein a class associated with the dot product that has the highest value is the predicted class; and outputting the predicted class.
9. The method of example 8, wherein determining which of the dot products has a highest value comprises applying an argument maximum function.
10. The method of any of examples 8, further comprising:
   updating the HDC ML model by:
      receiving the query vector as an encoded hypervector and the predicted class as a class label for the encoded hypervector,
      when the encoded hypervector is a first sample of the class in the first learning module, adding the received encoded hypervector to a class hypervector of the class of the first learning module,
      when the encoded hypervector is not the first sample of the class in the first learning module,
         computing a dot product between the encoded hypervector and each class hypervector of the first set of one or more class hypervectors,
         determining whether the computed dot product for the class is a match in the first learning module, wherein when the computed dot product is a match, adding the received encoded hypervector to a class hypervector of the class of the first learning module, and when the computed dot product is not a match evaluating the encoded hypervector using the second learning module.
11. The method of any of examples 10, wherein evaluating the encoded hypervector using the second learning module comprises:
when the encoded hypervector is a first sample of the class in the second learning module, adding the received encoded hypervector to a class hypervector of the class of the second learning module,
when the encoded hypervector is not the first sample of the class in the second learning module,
   computing a dot product between the encoded hypervector and each class hypervector of the second set of one or more class hypervectors,
   determining whether the computed dot product for the class is a match in the second learning module, wherein when the computed dot product is a match, adding the received encoded hypervector to a class hypervector of the class of the second learning module, and the computed dot product is not a match setting the class hypervectors of the first learning module to be a sum of the class hypervectors of the first learning module and the class hypervectors of the second learning module.
12. An apparatus comprising:
   processing hardware to execute a hyperdimensional computing (HDC) machine learning (ML) model training routine;
   memory to store the HDC ML model that comprises a first learning module to store a first set of one or more class hypervectors and a second learning module to store a second, different set of one or more class hypervectors, wherein the training routine comprises a method of:
      receiving an encoded hypervector and a class label for the encoded hypervector,
      when the encoded hypervector is a first sample of the class in the first learning module, adding the received encoded hypervector to a class hypervector of the class of the first learning module,
      when the encoded hypervector is not the first sample of the class in the first learning module,
         computing a dot product between the encoded hypervector and each class hypervector of the first set of one or more class hypervectors,
         determining whether the computed dot product for the class is a match in the first learning module, wherein when the computed dot product is a match, adding the received encoded hypervector to a class hypervector of the class of the first learning module, and when the computed dot product is not a match evaluating the encoded hypervector using the second learning module.
13. The apparatus of example 12, wherein evaluating the encoded hypervector using the second learning module comprises:
   when the encoded hypervector is a first sample of the class in the second learning module, adding the received encoded hypervector to a class hypervector of the class of the second learning module,
   when the encoded hypervector is not the first sample of the class in the second learning module,
      computing a dot product between the encoded hypervector and each class hypervector of the second set of one or more class hypervectors,
      determining whether the computed dot product for the class is a match in the second learning module, wherein when the computed dot product is a match, adding the received encoded hypervector to a class hypervector of the class of the second learning module, and the computed dot product is not a match setting the class hypervectors of the first learning module to be a sum of the class hypervectors of the first learning module and the class hypervectors of the second learning module.
14. The apparatus of any of examples 12-13, wherein the apparatus is a field programmable gate array.
15. The apparatus of any of examples 12-14, wherein the computed dot product for the class is a match in the second learning module when the computed dot product for the class has a highest value of the computed dot products.
16. The apparatus of any of examples 12-15, wherein the encoded hypervector is to be encoded using a plurality of codebooks.
17. The apparatus of example 15, wherein the processing hardware is an accelerator.
18. A non-transitory machine-readable storage medium storing thereon instructions which when executed cause a method to be performed, wherein the method comprises:
   receiving an encoded hypervector of a hyperdimensional computing (HDC) machine learning (ML) model and a class label for the encoded hypervector, the HDC ML model comprising a first learning module to store a first set of one or more class hypervectors and a second learning module to store a second set of one more class hypervectors, the second set of one or more class hypervectors being different from the first sect of one or more class hypervectors;
   evaluating the encoded hypervector using the first learning module by:
      when the encoded hypervector is a first sample of the class in the first learning module, adding the encoded hypervector to a class hypervector of the class of the first learning module, and
      when the encoded hypervector is not the first sample of the class in the first learning module:
         computing a dot product between the encoded hypervector and each class hypervector of the first set of one or more class hypervectors, and determining whether the computed dot product for the class is a match in the first learning module,
         when the computed dot product is a match, adding the encoded hypervector to a class hypervector of the class of the first learning module, and
         when the computed dot product is not a match evaluating the encoded hypervector using the second learning module.
19. The non-transitory machine-readable storage medium of example 18, wherein evaluating the encoded hypervector using the second learning module comprises:
   when the encoded hypervector is a first sample of the class in the second learning module, adding the encoded hypervector to a class hypervector of the class of the second learning module, and
   when the encoded hypervector is not the first sample of the class in the second learning module,
      computing a dot product between the encoded hypervector and each class hypervector of the second set of one or more class hypervectors,
      determining whether the computed dot product for the class is a match in the second learning module,
      when the computed dot product is a match, adding the received encoded hypervector to a class hypervector of the class of the second learning module, and
      when the computed dot product is not a match, setting the class hypervectors of the first learning module to be a sum of the class hypervectors of the first learning module and the class hypervectors of the second learning module.
20. The non-transitory machine-readable storage medium of example 18, wherein the computed dot product for the class is a match in the second learning module when the computed dot product for the class has a highest value of the computed dot products for the second set of one more class hypervectors.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. A method comprising:
receiving an encoded hypervector of a hyperdimensional computing (HDC) machine learning (ML) model and a class label for the encoded hypervector, the HDC ML model comprising a first learning module to store a first set of one or more class hypervectors and a second learning module to store a second set of one more class hypervectors, the second set of one or more class hypervectors being different from the first sect of one or more class hypervectors;
evaluating the encoded hypervector using the first learning module by:
when the encoded hypervector is a first sample of the class in the first learning module, adding the encoded hypervector to a class hypervector of the class of the first learning module, and
when the encoded hypervector is not the first sample of the class in the first learning module:
computing a dot product between the encoded hypervector and each class hypervector of the first set of one or more class hypervectors, and determining whether the computed dot product for the class is a match in the first learning module,
when the computed dot product is a match, adding the encoded hypervector to a class hypervector of the class of the first learning module, and
when the computed dot product is not a match evaluating the encoded hypervector using the second learning module.

2. The method of claim 1, wherein evaluating the encoded hypervector using the second learning module comprises:
when the encoded hypervector is a first sample of the class in the second learning module, adding the encoded hypervector to a class hypervector of the class of the second learning module, and
when the encoded hypervector is not the first sample of the class in the second learning module,
computing a dot product between the encoded hypervector and each class hypervector of the second set of one or more class hypervectors,
determining whether the computed dot product for the class is a match in the second learning module,
when the computed dot product is a match, adding the received encoded hypervector to a class hypervector of the class of the second learning module, and
when the computed dot product is not a match, setting the class hypervectors of the first learning module to be a sum of the class hypervectors of the first learning module and the class hypervectors of the second learning module.

3. The method of claim 2, further comprising:
resetting the second learning module to zero when computed dot product is not a match in the second learning module.

4. The method of claim 1, further comprising:
initializing all class hypervectors of the first learning module and the second learning module to zero.

5. The method of claim 1, wherein the computed dot product for the class is a match in the second learning module when the computed dot product for the class has a highest value of the computed dot products for the second set of one more class hypervectors.

6. The method of claim 1, further comprising:
generating the encoded hypervector using a plurality of codebooks.

7. The method of claim 1, wherein the training is in response to a request received at a cloud provider network service wherein the request includes at least one of an identifier of the HDC ML model to train, an identifier of a HDC machine learning algorithm to train, an indication of a location for training data, an indication of a location for validation and/or testing data, an algorithm to use for encoding, or an indication of a compute instance to use for training.

8. A method comprising:
encoding data into a query vector;
performing the inference to predict a class for data using a hyperdimensional computing (HDC) machine learning (ML) model, wherein the HDC ML model comprises a first learning module to store a first set of one or more class hypervectors and a second learning module to store a second, different set of one or more class hypervectors, by:
computing a dot product between the query vector and each class hypervector of a first memory module,
determining which of the dot products has a highest value, wherein a class associated with the dot product that has the highest value is the predicted class; and
outputting the predicted class.

9. The method of claim 8, wherein determining which of the dot products has a highest value comprises applying an argument maximum function.

10. The method of claim 8, further comprising:
updating the HDC ML model by:
receiving the query vector as an encoded hypervector and the predicted class as a class label for the encoded hypervector,
when the encoded hypervector is a first sample of the class in the first learning module, adding the received encoded hypervector to a class hypervector of the class of the first learning module,
when the encoded hypervector is not the first sample of the class in the first learning module,
computing a dot product between the encoded hypervector and each class hypervector of the first set of one or more class hypervectors,
determining whether the computed dot product for the class is a match in the first learning module, wherein when the computed dot product is a match, adding the received encoded hypervector to a class hypervector of the class of the first learning module, and when the computed dot product is not a match evaluating the encoded hypervector using the second learning module.

11. The method of claim 10, wherein evaluating the encoded hypervector using the second learning module comprises:
when the encoded hypervector is a first sample of the class in the second learning module, adding the received encoded hypervector to a class hypervector of the class of the second learning module,
when the encoded hypervector is not the first sample of the class in the second learning module,
computing a dot product between the encoded hypervector and each class hypervector of the second set of one or more class hypervectors,
determining whether the computed dot product for the class is a match in the second learning module, wherein when the computed dot product is a match, adding the received encoded hypervector to a class hypervector of the class of the second learning module, and the computed dot product is not a match setting the class hypervectors of the first learning module to be a sum of the class hypervectors of the first learning module and the class hypervectors of the second learning module.

12. An apparatus comprising:
processing hardware to execute a hyperdimensional computing (HDC) machine learning (ML) model training routine;
memory to store the HDC ML model that comprises a first learning module to store a first set of one or more class hypervectors and a second learning module to store a second, different set of one or more class hypervectors, wherein the training routine comprises a method of:
receiving an encoded hypervector and a class label for the encoded hypervector,
when the encoded hypervector is a first sample of the class in the first learning module, adding the received encoded hypervector to a class hypervector of the class of the first learning module,
when the encoded hypervector is not the first sample of the class in the first learning module,
computing a dot product between the encoded hypervector and each class hypervector of the first set of one or more class hypervectors,
determining whether the computed dot product for the class is a match in the first learning module, wherein when the computed dot product is a match, adding the received encoded hypervector to a class hypervector of the class of the first learning module, and when the computed dot product is not a match evaluating the encoded hypervector using the second learning module.

13. The apparatus of claim 12, wherein evaluating the encoded hypervector using the second learning module comprises:
when the encoded hypervector is a first sample of the class in the second learning module, adding the received encoded hypervector to a class hypervector of the class of the second learning module,
when the encoded hypervector is not the first sample of the class in the second learning module,
computing a dot product between the encoded hypervector and each class hypervector of the second set of one or more class hypervectors,
determining whether the computed dot product for the class is a match in the second learning module, wherein when the computed dot product is a match, adding the received encoded hypervector to a class hypervector of the class of the second learning module, and the computed dot product is not a match setting the class hypervectors of the first learning module to be a sum of the class hypervectors of the first learning module and the class hypervectors of the second learning module.

14. The apparatus of claim 12, wherein the apparatus is a field programmable gate array.

15. The apparatus of claim 12, wherein the computed dot product for the class is a match in the second learning module when the computed dot product for the class has a highest value of the computed dot products.

16. The apparatus of claim 12, wherein the encoded hypervector is to be encoded using a plurality of codebooks.

17. The apparatus of claim 15, wherein the processing hardware is an accelerator.

18. A non-transitory machine-readable storage medium storing thereon instructions which when executed cause a method to be performed, wherein the method comprises:
receiving an encoded hypervector of a hyperdimensional computing (HDC) machine learning (ML) model and a class label for the encoded hypervector, the HDC ML model comprising a first learning module to store a first set of one or more class hypervectors and a second learning module to store a second set of one more class hypervectors, the second set of one or more class hypervectors being different from the first sect of one or more class hypervectors;
evaluating the encoded hypervector using the first learning module by:
when the encoded hypervector is a first sample of the class in the first learning module, adding the encoded hypervector to a class hypervector of the class of the first learning module, and
when the encoded hypervector is not the first sample of the class in the first learning module:
computing a dot product between the encoded hypervector and each class hypervector of the first set of one or more class hypervectors, and determining whether the computed dot product for the class is a match in the first learning module,
when the computed dot product is a match, adding the encoded hypervector to a class hypervector of the class of the first learning module, and
when the computed dot product is not a match evaluating the encoded hypervector using the second learning module.

19. The non-transitory machine-readable storage medium of claim 18, wherein evaluating the encoded hypervector using the second learning module comprises:
when the encoded hypervector is a first sample of the class in the second learning module, adding the encoded hypervector to a class hypervector of the class of the second learning module, and
when the encoded hypervector is not the first sample of the class in the second learning module,
computing a dot product between the encoded hypervector and each class hypervector of the second set of one or more class hypervectors,
determining whether the computed dot product for the class is a match in the second learning module,
when the computed dot product is a match, adding the received encoded hypervector to a class hypervector of the class of the second learning module, and
when the computed dot product is not a match, setting the class hypervectors of the first learning module to be a sum of the class hypervectors of the first learning module and the class hypervectors of the second learning module.

20. The non-transitory machine-readable storage medium of claim 18, wherein the computed dot product for the class is a match in the second learning module when the computed dot product for the class has a highest value of the computed dot products for the second set of one more class hypervectors.
